(19) United States
(12) Patent Application Publication
(10) Pub. No.: US 2025/0296320 A1
(43) Pub. Date: Sep. 25, 2025

(54) Capacitive Load Drive Circuit, Liquid Ejection Apparatus, And Head Unit

(71) Applicant: SEIKO EPSON CORPORATION, Tokyo (JP)

(72) Inventors: Noritaka IDE, Shiojiri (JP); Kunio TABATA, Shiojiri (JP); Dai NOZAWA, Matsumoto (JP); Rika TANIMOTO, Matsumoto (JP); Satoru UEMATSU, Shiojiri (JP)

(21) Appl. No.: 19/086,238

(22) Filed: Mar. 21, 2025

(30) Foreign Application Priority Data
Mar. 22, 2024 (JP) 2024-046808

(51) Int. Cl. B41J 2/045

(52) U.S. Cl. CPC B41J 2/04541; B41J 2/0455; B41J 2/04551; B41J 2/04581; B41J 2/04588

(57) ABSTRACT

A capacitive load drive circuit includes: an amplifier circuit that outputs a first amplified modulation signal obtained by modulating a base drive signal and amplifying the modulation signal; a level switching signal output circuit that outputs a level switching signal; a level shift circuit that outputs the first amplified modulation signal or outputs a signal obtained by shifting a potential of the first amplified modulation signal as a second amplified modulation signal; a demodulation circuit that demodulates the second amplified modulation signal and outputs a drive signal; and a feedback circuit that outputs a feedback signal corresponding to the drive signal. A state of the level switching signal output circuit includes a first state in which the level switching signal according to the feedback signal is output, and a second state in which the level switching signal constant is output.

The present application is based on, and claims priority from JP Application Serial Number 2024-046808, filed Mar. 22, 2024, the disclosure of which is hereby incorporated by reference herein in its entirety.

### BACKGROUND

### 1. Technical Field

The present disclosure relates to a capacitive load drive circuit, a liquid ejection apparatus, and a head unit.

### 2. Related Art

As a liquid ejection apparatus that ejects a liquid to form an image or a document on a medium, a liquid ejection apparatus using a piezoelectric element is known. In such a liquid ejection apparatus, the piezoelectric elements are provided to correspond respectively to a plurality of nozzles that eject the liquid, and each of the plurality of nozzles is driven in accordance with a drive signal. When the piezoelectric element is driven, the liquid is ejected from the nozzle provided corresponding to the piezoelectric element. In order to operate such a piezoelectric element, it is necessary to supply a sufficient current. Therefore, the drive circuit for outputting the drive signal for driving the piezoelectric element includes an amplifier circuit for amplifying the source signal serving as the basis of the drive signal with an amplifier circuit.

JP-A-2010-124040 discloses a circuit that pulse-modulates a base drive signal serving as a basis of a drive signal, amplifies a modulation signal obtained by pulse-modulation, and outputs the amplified modulation signal as a drive signal.

However, from the viewpoint of reducing the power consumption in the drive circuit, the technique disclosed in JP-A-2010-124040 alone is not sufficient, and there is room for improvement.

### SUMMARY

According to an aspect of the present disclosure, there is provided a capacitive load drive circuit which is a capacitive load drive circuit for outputting a drive signal for driving a capacitive load, and the capacitive load drive circuit includes:
a modulation circuit configured to modulate a base drive signal serving as a basis of the drive signal and to output a modulation signal;
an amplifier circuit configured to output a first amplified modulation signal obtained by amplifying the modulation signal;
a level switching signal output circuit configured to output a level switching signal changing between a first potential and a second potential;
a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential;
a demodulation circuit configured to demodulate the second amplified modulation signal and to output the drive signal; and
a feedback circuit configured to output a feedback signal corresponding to the drive signal, in which
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

According to an aspect of the present disclosure, there is provided a liquid ejection apparatus including:
a conveyance unit configured to convey a medium;
a liquid ejection head configured to eject a liquid onto the medium in response to driving of a capacitive load; and
a capacitive load drive circuit configured to output a drive signal for driving the capacitive load, in which
the capacitive load drive circuit includes
   a modulation circuit configured to modulate a base drive signal serving as a basis of the drive signal and to output a modulation signal,
   an amplifier circuit configured to output a first amplified modulation signal obtained by amplifying the modulation signal,
   a level switching signal output circuit configured to output a level switching signal changing between a first potential and a second potential,
   a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential,
   a demodulation circuit configured to demodulate the second amplified modulation signal and to output the drive signal, and
   a feedback circuit configured to output a feedback signal corresponding to the drive signal, and
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

According to an aspect of the present disclosure, there is provided a head unit including:
a liquid ejection head configured to eject a liquid onto a medium in response to driving of a capacitive load; and
a capacitive load drive circuit configured to output a drive signal for driving the capacitive load, in which
the capacitive load drive circuit includes
   a modulation circuit configured to modulate a base drive signal serving as a basis of the drive signal and to output a modulation signal,
   an amplifier circuit configured to output a first amplified modulation signal obtained by amplifying the modulation signal,
   a level switching signal output circuit configured to output a level switching signal changing between a first potential and a second potential,
   a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential,
   a demodulation circuit configured to demodulate the second amplified modulation signal and to output the drive signal, and
   a feedback circuit configured to output a feedback signal corresponding to the drive signal, and
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

### BRIEF DESCRIPTION OF THE DRAWINGS

FIG. 1 is a diagram showing an example of a structure of a liquid ejection apparatus.

FIG. 2 is a diagram showing a functional configuration of the liquid ejection apparatus.

FIG. 3 is a diagram showing an example of arrangement of a plurality of ejection units in the head unit.

FIG. 4 is a diagram showing an example of a configuration of the ejection unit.

FIG. 5 is a diagram showing an example of a configuration of a voltage conversion circuit.

FIG. 6 is a diagram showing an operation of the voltage conversion circuit.

FIG. 7 is a diagram showing an example of a signal waveform of a drive signal COM.

FIG. 8 is a diagram showing an example of a functional configuration of a drive circuit.

FIG. 9 is a diagram illustrating an operation of the drive circuit.

FIG. 10 is a diagram showing an example of a configuration of a level switching signal output circuit.

FIG. 11 is a diagram showing an example of a configuration of a high pass filter provided in a feedback circuit.

FIG. 12 is a diagram illustrating an operation of the level switching signal output circuit.

FIG. 13 is a diagram showing an example of a configuration of a voltage conversion circuit according to Modification 1.

FIG. 14 is a diagram showing an example of a configuration of a voltage conversion circuit according to Modification 2.

FIG. 15 is a diagram showing a configuration of a drive circuit of a liquid ejection apparatus according to Modification 3.

### DESCRIPTION OF EMBODIMENTS

Hereinafter, a preferred embodiment of the present disclosure will be described using the drawings. The drawings to be used are for the sake of convenience of description. The embodiment to be described below does not unduly limit contents of the present disclosure described in the claims. All the configurations to be described below are not necessarily essential elements of the present disclosure.

In the following description, a serial printing type consumer inkjet printer is used as an example of a liquid ejection apparatus according to the present disclosure. However, the liquid ejection apparatus is not limited to the serial printing type, and may be a line printing type. In addition, the liquid ejection apparatus is not limited to a consumer inkjet printer, and may be a business inkjet printer for an office, or may be a portable inkjet printer which is driven by a battery or the like and can be carried. Further, the liquid ejection apparatus is not limited to an inkjet printer, and may be, for example, a color material ejection apparatus used for production of a color filter for a liquid crystal display or the like, an electrode material ejection apparatus used for formation of an electrode for an organic EL display, a field emission display, or the like, and a bioorganic material ejection apparatus used for production of a biochip.

### 1. Overview of Liquid Ejection Apparatus

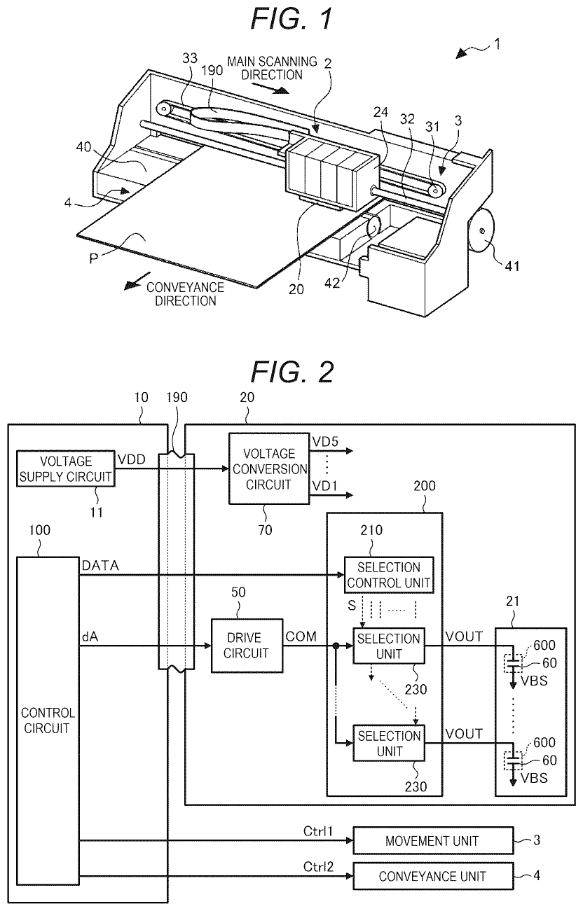

FIG. 1 is a diagram showing an example of a structure of a liquid ejection apparatus 1. As shown in FIG. 1, the liquid ejection apparatus 1 includes a vehicle 2 and a movement unit 3 that reciprocates the vehicle 2 along a main scanning direction.

The movement unit 3 includes carriage motors 31 which are drive sources of reciprocating movement of the vehicle 2 along the main scanning direction, a carriage guide shaft 32 both ends of which are fixed, and a timing belt 33 which extends substantially parallel to the carriage guide shaft 32 and is driven by the carriage motor 31.

The vehicle 2 includes a carriage 24. The carriage 24 is supported by the carriage guide shaft 32 in a reciprocally movable manner, and is fixed to a part of the timing belt 33. When the timing belt 33 travels forward and backward by the carriage motor 31, the vehicle 2 including the carriage 24 reciprocates while being guided by the carriage guide shaft 32. In addition, a head unit 20 is located in a portion of the vehicle 2 facing a medium P. That is, the head unit 20 is mounted on the carriage 24. A large number of nozzles that eject ink as an example of a liquid are located on a surface of the head unit 20 facing the medium P. Various control signals for controlling an operation of the head unit 20 are supplied to the head unit 20 via a cable 190. A flexible flat cable or the like that can slide following the reciprocating movement of the vehicle 2 can be used as the cable 190.

The liquid ejection apparatus 1 includes a conveyance unit 4 that conveys the medium P on a platen 40 along a conveyance direction. The conveyance unit 4 includes a conveyance motor 41 that is a drive source for conveying the medium P, and a conveyance roller 42 that conveys the medium P along the conveyance direction by rotating with a drive force of the conveyance motor 41.

In the liquid ejection apparatus 1 configured as described above, the head unit 20 ejects ink onto the medium P in synchronization with a timing at which the medium P is conveyed by the conveyance unit 4. Accordingly, the ink ejected by the head unit 20 lands on a desired position of the medium P, and a desired image or character is formed on a surface of the medium P.

Next, a functional configuration of the liquid ejection apparatus 1 will be described. FIG. 2 is a diagram showing a functional configuration of the liquid ejection apparatus 1. As shown in FIG. 2, the liquid ejection apparatus 1 includes a control unit 10, the head unit 20, the movement unit 3, the conveyance unit 4, and the cable 190. The cable 190 electrically couples the control unit 10 and the head unit 20.

The control unit 10 includes a voltage supply circuit 11 and a control circuit 100.

The voltage supply circuit 11 outputs a voltage signal VDD, which is a DC voltage signal having a constant voltage value of voltage vdd, from a commercial AC power supply supplied from the outside of the liquid ejection apparatus 1. The voltage signal VDD output by the voltage supply circuit 11 is supplied to various components of the control unit 10 and is also supplied to the head unit 20. Here, in the liquid ejection apparatus 1 according to the embodiment, the voltage vdd which is the voltage value of the voltage signal VDD output by the voltage supply circuit 11 is 5 V. The voltage supply circuit 11 may include, for example, an AC/DC converter that generates a DC voltage signal having a predetermined voltage value from a commercial AC power supply. The voltage supply circuit 11 may be various batteries such as a primary battery and a secondary battery. The liquid ejection apparatus 1 may have a configuration in which the voltage supply circuit 11 is not provided, and the voltage signal VDD is supplied as a DC voltage signal from a power supply circuit provided outside the liquid ejection apparatus 1.

The control circuit 100 is an external device (not illustrated) provided outside the liquid ejection apparatus 1, and is supplied with image data from, for example, a host computer or the like. The control circuit 100 generates various control signals for controlling each unit of the liquid ejection apparatus 1 by performing various types of image processing or the like on the supplied image data, and outputs the control signals to each unit.

Specifically, the control circuit 100 generates a control signal Ctrl1 for controlling the reciprocating movement of the vehicle 2 based on the image data, and outputs the control signal Ctrl1 to the carriage motor 31 provided in the movement unit 3. The control circuit 100 generates a control signal Ctrl2 for controlling the conveyance of the medium P based on the image data, and outputs the control signal Ctrl2 to the conveyance motor 41 provided in the conveyance unit 4. Accordingly, the reciprocating movement of the vehicle 2 along the main scanning direction and the conveyance of the medium P along the conveyance direction are controlled by the control circuit 100. That is, the head unit 20 can eject ink onto the medium P at a predetermined timing synchronized with the conveyance of the medium P. Accordingly, the ink can be landed at a desired position of the medium P, and a desired image or character can be formed on the medium P.

After the control signal Ctrl1 for controlling the reciprocating movement of the vehicle 2 is subjected to signal conversion by a carriage motor driver (not illustrated), the control circuit 100 may supply the converted signal Ctrl1 to the movement unit 3.

Similarly, after the control signal Ctrl2 for controlling the conveyance of the medium P is subjected to signal conversion by a conveyance motor driver (not illustrated), the control circuit 100 may supply the converted control signal Ctrl2 to the conveyance unit 4.

In addition, the control circuit 100 generates a drive data signal DATA and a base drive signal dA for controlling the operation of the head unit 20 and outputs the signals to the head unit 20.

The head unit 20 includes a drive circuit 50, a voltage conversion circuit 70, a selection control circuit 200, and a liquid ejection head 21. The selection control circuit 200 includes a selection control unit 210 and a plurality of selection units 230, and the liquid ejection head 21 includes a plurality of ejection units 600 each including a piezoelectric element 60. At this time, each of the plurality of selection units 230 of the selection control circuit 200 is provided corresponding to the piezoelectric element 60 provided in each of the plurality of ejection units 600 of the liquid ejection head 21.

The voltage signal VDD output from the voltage supply circuit 11 is input to the voltage conversion circuit 70. The voltage conversion circuit 70 boosts the voltage signal VDD input thereto and outputs the boosted voltage signal as voltage signals VD1 to VD5 used in the head unit 20. Here, in the embodiment, the voltage signal VD1 is a DC voltage signal having a constant voltage value of a voltage vd1, and the voltage vd1 is 8.4 V. The voltage signal VD2 is a DC voltage signal having a constant voltage value of a voltage vd2, and the voltage vd2 is 16.8 V. The voltage signal VD3 is a DC voltage signal having a constant voltage value of a voltage vd3 and the voltage vd3 is 25.2 V. The voltage signal VD4 is a DC voltage signal having a constant voltage value of a voltage vd4, and the voltage vd4 is 33.6 V. The voltage signal VD5 is a DC voltage signal having a constant voltage value of a voltage vd5 and the voltage vd5 is 42 V. Details of the configuration and operation of the voltage conversion circuit 70 will be described below.

The base drive signal dA output by the control unit 10 is input to the drive circuit 50. At least any one of the voltage signals VD1 to VD5 output by the voltage conversion circuit 70 is input to the drive circuit 50. The base drive signal dA is a digital signal including information defining a signal waveform of a drive signal COM for driving the piezoelectric element 60 described below. The drive circuit 50 converts the base drive signal dA into an analog signal, and then amplifies the converted analog signal to generate and output the drive signal COM. Details of a configuration and an operation of the drive circuit 50 will be described below.

The drive data signal DATA output by the control unit 10 is input to the selection control unit 210 of the selection control circuit 200. The voltage signal VD5 output from the voltage conversion circuit 70 is supplied to the selection control unit 210. The selection control unit 210 generates, based on the drive data signal DATA, a signal for instructing whether the drive signal COM is to be selected or not to be selected for each of the selection units 230, corresponding to each of the plurality of selection units 230. Then, the selection control unit 210 converts a logic level of the generated signal into a high-amplitude logic signal based on the voltage vd5, which is the voltage value of the voltage signal VD5, and outputs the converted signal as a selection signal S to the corresponding selection unit 230.

The drive signal COM and the corresponding selection signal S are input to each of the plurality of selection units 230. Each of the plurality of selection units 230 generates a drive signal VOUT by selecting or not selecting the drive signal COM based on the selection signal S. The plurality of selection units 230 supply the generated drive signal VOUT to one end of the piezoelectric element 60 provided in the corresponding ejection unit 600 provided in the liquid ejection head 21.

Further, a reference voltage signal VBS is commonly supplied to the other end of the piezoelectric element 60 provided in the plurality of ejection units 600. The reference voltage signal VBS is a signal having a constant voltage value functioning as a reference potential for driving the piezoelectric element 60 driven by the drive signal VOUT, and may be, for example, a DC voltage signal of 5.5 V, 6 V, or the like, or may be a signal having a constant voltage value at a ground potential.

The piezoelectric element 60 is provided corresponding to each of the plurality of nozzles in the head unit 20. The piezoelectric element 60 is driven according to a potential difference between the drive signal VOUT supplied to one end and the reference voltage signal VBS supplied to the other end. An amount of ink corresponding to the drive amount of the piezoelectric element 60 is ejected from the ejection unit 600 including the piezoelectric element 60.

FIG. 2 illustrates a case where the head unit 20 includes one liquid ejection head 21, and the head unit 20 may include a plurality of liquid ejection heads 21 according to the type, the number, and the like of ink to be ejected.

As described above, the liquid ejection apparatus 1 according to the embodiment includes the conveyance unit 4 that conveys the medium P, the liquid ejection head 21 that includes a plurality of ejection units 600 including the piezoelectric elements 60 and ejecting ink onto the medium P by driving the piezoelectric elements 60 and ejects liquid onto the medium P by driving the piezoelectric elements 60, the voltage conversion circuit 70 that boosts the voltage signal VDD and outputs the voltage signal VD1 of the voltage vd1, the voltage signal VD2 of the voltage vd2, the voltage signal VD3 of the voltage vd3, the voltage signal VD4 of the voltage vd4, and the voltage signal VD5 of the voltage vd5, and the drive circuit 50 that is supplied with at least any one of the voltage signals VD1 to VD5 and outputs the drive signal COM for driving the piezoelectric elements 60.

### 2. Configuration of Ejection Unit

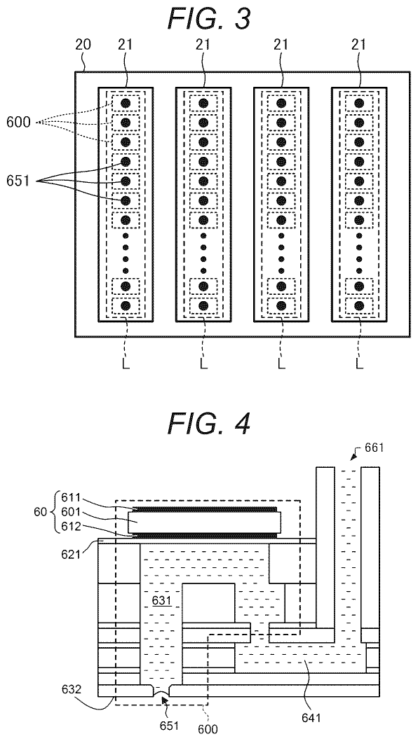

Next, an example of the configurations of the plurality of ejection units 600 of the liquid ejection head 21 and the arrangement of the plurality of ejection units 600 in the head unit 20 will be described. FIG. 3 is a diagram showing an example of arrangement of the plurality of ejection units 600 in the head unit 20. FIG. 3 illustrates a case where the head unit 20 includes four liquid ejection heads 21.

As shown in FIG. 3, the four liquid ejection heads 21 each include a plurality of ejection units 600 provided in a row in one direction. That is, the liquid ejection head 21 includes a nozzle row L in which nozzles 651 described below provided in the ejection unit 600 are arranged in one direction. In addition, the liquid ejection heads 21 are located side by side in a direction intersecting the nozzle row L in the head unit 20. That is, nozzle rows L the number of which is the same as the liquid ejection heads 21 are formed in the head unit 20. The arrangement of the nozzles 651 in the nozzle row L is not limited to one row, and for example, the nozzles 651 may be arranged in a staggered manner such that a position of the even-numbered nozzle 651 counted from one end portion of the plurality of nozzles 651 and an odd-numbered nozzle 651 counted from one end portion of the plurality of nozzles 651 are different from each other, or one nozzle row L may be formed by arranging the plurality of nozzles 651 in two or more rows in parallel.

Next, an example of a configuration of the ejection unit 600 will be described. FIG. 4 is a diagram showing the example of the configuration of the ejection unit 600. As shown in FIG. 4, the ejection unit 600 includes the piezoelectric element 60, a vibration plate 621, a cavity 631, and the nozzle 651. The vibration plate 621 is displaced by driving of the piezoelectric element 60 provided on an upper surface in FIG. 4. The vibration plate 621 functions as a diaphragm that increases/reduces an internal volume of the cavity 631. The inside of the cavity 631 is filled with ink. The cavity 631 functions as a pressure chamber internal volume of which changes due to the displacement of the vibration plate 621 caused by the driving of the piezoelectric element 60. The nozzle 651 is an opening that is provided in a nozzle plate 632 and communicates with the cavity 631. As the internal volume of the cavity 631 changes, the ink stored inside the cavity 631 is discharged from the nozzle 651.

The piezoelectric element 60 has a structure in which a piezoelectric body 601 is sandwiched between a pair of electrodes 611 and 612. In the piezoelectric body 601 having this structure, the central portions of the electrode 611 and 612 and the vibration plate 621 bend in an up-down direction in FIG. 4 with respect to both end portions according to the potential difference between the electrode 611 and the electrode 612.

Specifically, the drive signal VOUT is supplied to the electrode 611 which is one end of the piezoelectric element 60, and the reference voltage signal VBS is supplied to the electrode 612 which is the other end. When the piezoelectric element 60 is driven upward according to the change in the voltage of the drive signal VOUT, the vibration plate 621 is displaced upward. As a result, the internal volume of the cavity 631 increases. Therefore, the ink stored in a reservoir 641 is drawn into the cavity 631. On the other hand, when the piezoelectric element 60 is driven downward according to the change in the voltage value of the drive signal VOUT, the vibration plate 621 is displaced downward. As a result, the internal volume of the cavity 631 is reduced. Therefore, an amount of ink corresponding to a degree of reduction in the internal volume of the cavity 631 is discharged from the nozzle 651.

As described above, the liquid ejection head 21 includes the piezoelectric element 60 and ejects ink onto the medium P by driving the piezoelectric element 60. The ejection unit 600 and the piezoelectric element 60 provided in the ejection unit 600 are not limited to the illustrated configuration, and may have a structure in which the piezoelectric element 60 is driven based on the drive signal VOUT and ink can be ejected from the corresponding nozzle 651 by driving the piezoelectric element 60.

### 3. Configuration and Operation of Voltage Conversion Circuit

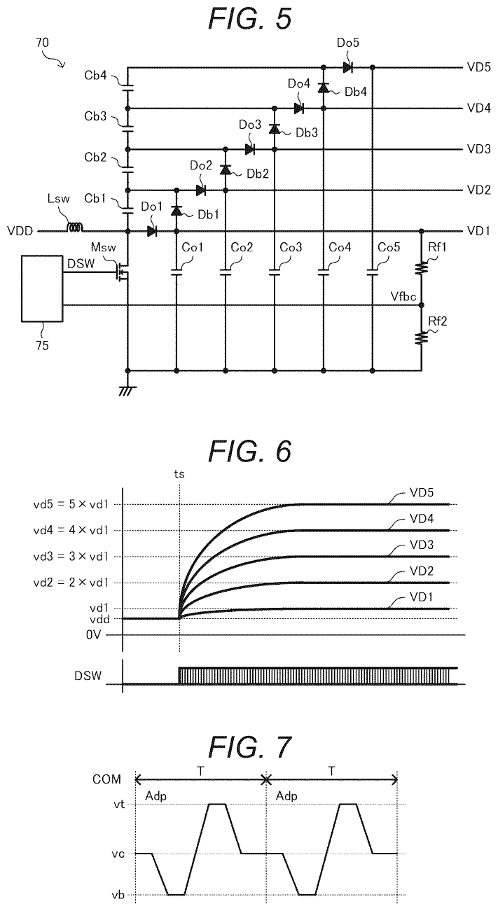

Next, the configuration and operation of the voltage conversion circuit 70 will be described. FIG. 5 is a diagram showing an example of the configuration of the voltage conversion circuit 70. As shown in FIG. 5, the voltage conversion circuit 70 includes an inductor Lsw, a transistor Msw, capacitors Co1 to Co5 and Cb1 to Cb4, diodes Do1 to Do5 and Db1 to Db4, resistors Rf1, Rf2, and a boost control circuit 75.

The voltage signal VDD output from the voltage supply circuit 11 is supplied to one end of the inductor Lsw. The transistor Msw is an N-channel MOSFET. The transistor Msw includes a drain terminal to which the other end of the inductor Lsw is electrically coupled, a source terminal to which a ground potential is supplied, and a gate terminal to which a gate drive signal DSW output by the boost control circuit 75 is input. An anode terminal of the diode Do1 is electrically coupled to the other end of the inductor Lsw. One end of the capacitor Co1 is electrically coupled to a cathode terminal of the diode Do1, and the ground potential is supplied to the other end of the capacitor Co1. One end of the resistor Rf1 is electrically coupled to the cathode terminal of the diode Do1 and one end of the capacitor Co1. One end of the resistor Rf2 is electrically coupled to the other end of the resistor Rf1, and the ground potential is supplied to the other end of the resistor Rf2. A voltage value of a signal generated at a coupling point at which the other end of the resistor Rf1 and one end of the resistor Rf2 are electrically coupled is input to the boost control circuit 75 as a constant voltage feedback signal Vfbc. The boost control circuit 75 controls a duty ratio of the output gate drive signal DSW so that the voltage value of the constant voltage feedback signal Vfbc input thereto reaches a predetermined value.

One end of the capacitor Cb1 is electrically coupled to an anode terminal of the diode Do1. An anode terminal of the diode Db1 is electrically coupled to the cathode terminal of the diode Do1. An anode terminal of the diode Do2 is electrically coupled to the other end of the capacitor Cb1 and a cathode terminal of the diode Db1. One end of the capacitor Co2 is electrically coupled to a cathode terminal of the diode Do2, and the ground potential is supplied to the other end of the capacitor Co2.

One end of the capacitor Cb2 is electrically coupled to an anode terminal of the diode Do2. An anode terminal of the diode Db2 is electrically coupled to the cathode terminal of the diode Do2. An anode terminal of the diode Do3 is electrically coupled to the other end of the capacitor Cb2 and a cathode terminal of the diode Db2. One end of the capacitor Co3 is electrically coupled to a cathode terminal of the diode Do3, and the ground potential is supplied to the other end of the capacitor Co3.

One end of the capacitor Cb3 is electrically coupled to an anode terminal of the diode Do3. An anode terminal of the diode Db3 is electrically coupled to the cathode terminal of the diode Do3. An anode terminal of the diode Do4 is electrically coupled to the other end of the capacitor Cb3 and a cathode terminal of the diode Db3. One end of the capacitor Co4 is electrically coupled to a cathode terminal of the diode Do4, and the ground potential is supplied to the other end of the capacitor Co4.

One end of the capacitor Cb4 is electrically coupled to an anode terminal of the diode Do4. An anode terminal of the diode Db4 is electrically coupled to the cathode terminal of the diode Do4. An anode terminal of the diode Do5 is electrically coupled to the other end of the capacitor Cb4 and a cathode terminal of the diode Db4. One end of the capacitor Co5 is electrically coupled to a cathode terminal of the diode Do5, and the ground potential is supplied to the other end of the capacitor Co5.

That is, the voltage conversion circuit 70 includes the inductor Lsw having one end supplied with the voltage signal VDD, the transistor Msw having a drain terminal, which is one end, electrically coupled to the other end of the inductor Lsw, the diode Do1 having an anode terminal electrically coupled to the drain terminal, which is one end, of the transistor Msw, the capacitor Co1 having one end electrically coupled to the cathode terminal of the diode Do1, the capacitor Cb1 having one end electrically coupled to the drain terminal, which is one end, of the transistor Msw, the diode Db1 having an anode terminal electrically coupled to the cathode terminal of the diode Do1, the diode Do2 having an anode terminal electrically coupled to the cathode terminal of the diode Db1 and the other end of the capacitor Cb1, and the capacitor Co2 having one end electrically coupled to the cathode terminal of the diode Do2, and the voltage conversion circuit 70 outputs a voltage value at one end of the capacitor Co1 as the voltage signal VD1 and outputs a voltage value at one end of the capacitor Co2 as the voltage signal VD2.

The voltage conversion circuit 70 includes the diodes Do3, Do4, and Do5, the capacitors Co3, Co4, and Co5, the diodes Db2, Db3, and Db4, and the capacitors Cb2, Cb3, and Cb4, and outputs the voltage signals VD3, VD4, and VD5.

Specifically, one end of the capacitor Cb2 is electrically coupled to the anode terminal of the diode Do2, and the other end thereof is electrically coupled to the anode terminal of the diode Do3. An anode terminal of the diode Db2 is electrically coupled to the cathode terminal of the diode Do2, and a terminal thereof is electrically coupled to the anode terminal of the diode Do3. A cathode terminal of the diode Do3 is electrically coupled to one end of the capacitor Co3. One end of the capacitor Cb3 is electrically coupled to the anode terminal of the diode Do3, and the other end thereof is electrically coupled to the anode terminal of the diode Do4. An anode terminal of the diode Db3 is electrically coupled to the cathode terminal of the diode Do3, and a cathode terminal thereof is electrically coupled to the anode terminal of the diode Do4. A cathode terminal of the diode Do4 is electrically coupled to one end of the capacitor Co4. One end of the capacitor Cb4 is electrically coupled to the anode terminal of the diode Do4, and the other end thereof is electrically coupled to the anode terminal of the diode Do5. An anode terminal of the diode Db4 is electrically coupled to the cathode terminal of the diode Do4, and a cathode terminal thereof is electrically coupled to the anode terminal of the diode Do5. A cathode terminal of the diode Do5 is electrically coupled to one end of the capacitor Co5. The voltage conversion circuit 70 outputs a voltage value at one end of the capacitor Co3 as the voltage signal VD3, outputs a voltage value at one end of the capacitor Co4 as the voltage signal VD4, and outputs a voltage value at one end of the capacitor Co5 as the voltage signal VD5.

The voltage conversion circuit 70 configured as described above boosts the voltage vdd, which is the voltage value of the input voltage signal VDD, and generates and outputs the voltage signal VD1 having a voltage value of the voltage vd1, the voltage signal VD2 having a voltage value of the voltage vd2, the voltage signal VD3 having a voltage value of the voltage vd3, the voltage signal VD4 having a voltage value of the voltage vd4, and the voltage signal VD5 having a voltage value of the voltage vd5.

Here, in the liquid ejection apparatus 1 according to the embodiment, the voltage conversion circuit 70 outputs signals of five types of voltage values, the voltage signals VD1 to VD5, and the voltage conversion circuit 70 may output signals of five or more types of voltage values.

Specifically, the voltage conversion circuit 70 may include diodes Do3 to Do[n] (n is an integer of 3 or more), capacitors Co3 to Co[n], diodes Db2 to Db[n−1], and capacitors Cb2 to Cb[n−1] in addition to the diodes Do1 and Do2, the capacitors Co1 and Co2, the diode Db1, and the capacitor Cb1, and may output voltage signals VD3 to VD [n] in addition to the voltage signals VD1 and VD2.

At this time, one end of a capacitor Cb[i−1] (i is an integer of 3 or more and n or less) is electrically coupled to an anode terminal of a diode Do[i−1], and the other end thereof is electrically coupled to an anode terminal of a diode Do[i]. An anode terminal of the diode Do[i−1] is electrically coupled to a cathode terminal of the diode Do[i−1], and a cathode terminal thereof is electrically coupled to the anode terminal of the diode Do[i]. A cathode terminal of the diode Do[i] is electrically coupled to one end of a capacitor Co[i]. Accordingly, the voltage conversion circuit 70 outputs a voltage value at one end of the capacitor Co[i] as a voltage signal VDi.

FIG. 6 is a diagram illustrating an operation of the voltage conversion circuit 70. Here, in the following description, controlling the drain terminal and the source terminal of the transistor Msw to be conductive may be referred to as “on”, and controlling the drain terminal and the source terminal of the transistor Msw to be non-conductive may be referred to as “off”. An operation in which the transistor Msw is repeatedly turned off and off may be referred to as a switching operation. In the following description, the forward drop voltage of each of the diodes Do1 to Do5 and Db1 to Db4 included in the voltage conversion circuit 70 is 0 V.

As shown in FIG. 6, before a time point ts at which the transistor Msw starts the switching operation, the voltage conversion circuit 70 outputs voltage signals VD1 to VD5 having a constant voltage value of the voltage vdd. Therefore, before the time point ts at which the transistor Msw starts the switching operation, each of the voltages vd1 to vd5 is approximately equal to the voltage vdd.

Thereafter, at the time point ts, the boost control circuit 75 starts outputting the gate drive signal DSW having a logic level changing between an H level and an L level in a predetermined cycle. Accordingly, the switching operation of the transistor Msw is started. Accordingly, the voltage value of each of the voltage signals VD1 to VD5 output by the boost control circuit 75 increases.

Specifically, during a period in which the transistor Msw is controlled to be turned on, the current generated along with the propagation of the voltage signal VDD flows to a wiring pattern of the ground potential via the inductor Lsw and the transistor Msw. At this time, energy corresponding to the current generated along with the propagation of the voltage signal VDD is accumulated in the inductor Lsw.

Thereafter, when the transistor MSW is controlled to be turned off, a current that accompanies the release of the energy accumulated in the inductor Lsw is supplied to the capacitor Co1 via the diode Do1 in addition to the current generated along with propagation of the voltage signal VDD. Therefore, charges corresponding to the current generated along with the propagation of the voltage signal VDD and charges corresponding to the current that accompanies the release of the energy accumulated in the inductor Lsw are accumulated in the capacitor Co1. As a result, the voltage value at one end of the capacitor Co1, which is a potential difference between both ends of the capacitor Co1, increases, and the voltage value at one end of the capacitor Co1 becomes larger than the voltage value of the voltage signal VDD. The voltage conversion circuit 70 outputs a signal of a voltage value at one end of the capacitor Co1 as the voltage signal VD1.

During the period in which the transistor Msw is controlled to be turned on, the energy corresponding to the current generated along with the propagation of the voltage signal VDD is accumulated in the inductor Lsw as described above. In addition, during the period in which the transistor Msw is controlled to be turned on, the ground potential is supplied to one end of the capacitor Cb1, and the voltage signal VD1 is supplied to the other end of the capacitor Cb1 via the diode Db1, so that charges corresponding to the voltage vd1 are accumulated in the capacitor Cb1.

Thereafter, when the transistor MSW is controlled to be turned off, the current that accompanies the release of the energy accumulated in the inductor Lsw and a current corresponding to release of the charges accumulated in the capacitor Cb1 are supplied to the capacitor Co2 via the diode Do2 in addition to the current generated along with the propagation of the voltage signal VDD. Therefore, the charges corresponding to the current generated along with the propagation of the voltage signal VDD, the charges corresponding to the current that accompanies the release of the energy accumulated in the inductor Lsw, and the charges corresponding to the current that accompanies the release of the charges accumulated in the capacitor Cb1 are accumulated in the capacitor Co2. That is, the capacitor Co2 stores charges in an amount corresponding to the voltage vd1 in addition to the same amount of charges as the amount of the charges stored in the capacitor Co1. As a result, the voltage value at one end of the capacitor Co2, which is a potential difference between both ends of the capacitor Co2, is a value obtained by adding the voltage vd1 to the voltage value at one end of the capacitor Co1, and is approximately twice the voltage vd1. The voltage conversion circuit 70 outputs a signal of the voltage value at one end of the capacitor Co2 as the voltage signal VD2.

During the period in which the transistor Msw is controlled to be turned on, the energy corresponding to the current generated along with the propagation of the voltage signal VDD is accumulated in the inductor Lsw as described above. In addition, during the period in which the transistor Msw is controlled to be turned on, the voltage signal VD1 is supplied to one end of the capacitor Cb2, and the voltage signal VD2 is supplied to the other end of the capacitor Cb2 via the diode Db2, so that charges corresponding to the voltage vd1, which is a difference between the voltage value of the voltage signal VD1 and the voltage value of the voltage signal VD2, are accumulated in the capacitor Cb2.

Thereafter, when the transistor Msw is controlled to be turned off, the current that accompanies the release of the energy accumulated in the inductor Lsw and a current corresponding to the release of the charges accumulated in the capacitors Cb1 and Cb2 are supplied to the capacitor Co3 via the diode Do3 in addition to the current generated along with propagation of the voltage signal VDD. Therefore, the charges corresponding to the current generated along with the propagation of the voltage signal VDD, the charges corresponding to the current that accompanies the release of the energy accumulated in the inductor Lsw, and charges corresponding to the current that accompanies the release of the charges accumulated in the capacitors Cb1 and Cb2 are accumulated in the capacitor Co3. That is, the capacitor Co3 stores charges in an amount corresponding to an amount approximately twice the voltage vd1, which are charges in an amount corresponding to the voltage vd2 which is the voltage value of the voltage signal VD2, in addition to the same amount of charges as the amount of the charges stored in the capacitor Co1. As a result, the voltage value at one end of the capacitor Co3, which is a potential difference between both ends of the capacitor Co3, is a value obtained by adding the voltage vd1 to the voltage value at one end of the capacitor Co2, and is approximately three times the voltage vd1. The voltage conversion circuit 70 outputs a signal of the voltage value at one end of the capacitor Co3 as the voltage signal VD3.

During the period in which the transistor Msw is controlled to be turned on, the energy corresponding to the current generated along with the propagation of the voltage signal VDD is accumulated in the inductor Lsw as described above. In addition, during the period in which the transistor Msw is controlled to be turned on, the voltage signal VD2 is supplied to one end of the capacitor Cb3, and the voltage signal VD3 is supplied to the other end of the capacitor Cb3 via the diode Db3, so that charges corresponding to the voltage vd1, which is a difference between the voltage value of the voltage signal VD2 and the voltage value of the voltage signal VD3, are accumulated in the capacitor Cb3.

Thereafter, when the transistor Msw is controlled to be turned off, the current that accompanies the release of the energy accumulated in the inductor Lsw and a current corresponding to release of the charges accumulated in the capacitors Cb1, Cb2, and Cb3 are supplied to the capacitor Co4 via the diode Do4 in addition to the current generated along with the propagation of the voltage signal VDD. Therefore, the charges corresponding to the current generated along with the propagation of the voltage signal VDD, the charges corresponding to the current that accompanies the release of the energy accumulated in the inductor Lsw, and the charges corresponding to the current that accompanies the release of the charges accumulated in the capacitors Cb1, Cb2, and Cb3 are accumulated in the capacitor Co4. That is, the capacitor Co4 stores charges in an amount corresponding to an amount approximately three times the voltage vd1, which are charges in an amount corresponding to the voltage vd3 which is the voltage value of the voltage signal VD3, in addition to the same amount of charges as the amount of the charges stored in the capacitor Co1. As a result, the voltage value at one end of the capacitor Co4, which is a potential difference between both ends of the capacitor Co4, is a value obtained by adding the voltage vd1 to the voltage value at one end of the capacitor Co3, and is approximately four times the voltage vd1. The voltage conversion circuit 70 outputs a signal of the voltage value at one end of the capacitor Co4 as the voltage signal VD4.

During the period in which the transistor Msw is controlled to be turned on, the energy is accumulated in the inductor Lsw as described above by the current generated along with the propagation of the voltage signal VDD. In addition, during the period in which the transistor Msw is controlled to be turned on, the voltage signal VD3 is supplied to one end of the capacitor Cb4, and the voltage signal VD4 is supplied to the other end of the capacitor Cb4 via the diode Db4, so that charges corresponding to the voltage vd1, which is a difference between the voltage value of the voltage signal VD3 and the voltage value of the voltage signal VD4, are accumulated in the capacitor Cb4.

Thereafter, when the transistor Msw is controlled to be turned off, the current that accompanies the release of the energy accumulated in the inductor Lsw and a current according to release of the charges accumulated in the capacitors Cb1, Cb2, Cb3, and Cb4 are supplied to the capacitor Co5 via the diode Do5 in addition to the current generated along with the propagation of the voltage signal VDD. Therefore, the charges corresponding to the current generated along with the propagation of the voltage signal VDD, the charges corresponding to the current that accompanies the release of the energy accumulated in the inductor Lsw, and the charges corresponding to the current that accompanies the release of the charges accumulated in the capacitors Cb1, Cb2, Cb3, and Cb4 are accumulated in the capacitor Co5. That is, the capacitor Co5 stores charges in an amount corresponding to an amount approximately four times the voltage vd1, which are charges in an amount corresponding to the voltage vd4 which is the voltage value of the voltage signal VD4, in addition to the same amount of charges as the amount of the charges stored in the capacitor Co1. As a result, the voltage value at one end of the capacitor Co5, which is a potential difference between both ends of the capacitor Co5, is a value obtained by adding the voltage vd1 to the voltage value at one end of the capacitor Co4, and is approximately five times the voltage vd1. The voltage conversion circuit 70 outputs a signal of the voltage value at one end of the capacitor Co5 as the voltage signal VD5.

That is, the voltage conversion circuit 70 outputs the voltage vd1, the voltage vd2 that is approximately twice the voltage vd1, the voltage vd3 that is approximately three times the voltage vd1, the voltage vd4 that is approximately four times the voltage vd1, and the voltage vd5 that is approximately five times the voltage vd1.

As described above, the voltage conversion circuit 70 outputs the voltage signals VD1 to VD5 obtained by boosting the input voltage signal VDD with the switching operation of the transistor Msw. At this time, the voltages vd1 to vd5, which are the voltage values of the voltage signals VD1 to VD5 output by the voltage conversion circuit 70, respectively, are determined by the duty ratio of the switching operation of the transistor Msw. In the voltage conversion circuit 70 according to the embodiment, the voltage vd1, which is a voltage value of the voltage signal VD1 among the voltage signals VD1 to VD5 output by the voltage conversion circuit 70, is divided by the resistors Rf1 and Rf2, and the divided signal is fed back to the boost control circuit 75 as the constant voltage feedback signal Vfbc. Then, the boost control circuit 75 controls the duty ratio of the output gate drive signal DSW so that the voltage value of the constant voltage feedback signal Vfbc corresponding to the voltage vd1, which is the voltage value of the voltage signal VD1, reaches a predetermined value. Accordingly, the voltage vd1 which is the voltage value of the voltage signal VD1 output by the voltage conversion circuit 70 is controlled to a predetermined value, and the voltage vd2 which is the voltage value of the voltage signal VD2 and is approximately twice the voltage vd1, the voltage vd3 which is the voltage value of the voltage signal VD3 and is approximately three times the voltage vd1, the voltage vd4 which is the voltage value of the voltage signal VD4 and is approximately four times the voltage vd1, and the voltage vd5 which is the voltage value of the voltage signal VD5 and is approximately five times the voltage vd1 are also controlled to predetermined values.

When the voltage conversion circuit 70 feeds back a signal corresponding to a voltage value of any one of the voltage signals VD2 to VD5, instead of the voltage signal VD1, to the boost control circuit 75, the boost control circuit 75 may control the duty ratio of the output gate drive signal DSW so that the voltage value of any one of the voltage signals VD2 to VD5 reaches a predetermined value.

In the voltage conversion circuit 70 shown in FIG. 5, the ground potential is supplied to each of the other end of the capacitor Co2, the other end of the capacitor Co3, the other end of the capacitor Co4, and the other end of the capacitor Co5, and the other end of the capacitor Co2 may be electrically coupled to one end of the capacitor Co1, the other end of the capacitor Co3 may be electrically coupled to one end of the capacitor Co2, the other end of the capacitor Co4 may be electrically coupled to one end of the capacitor Co3, and the other end of the capacitor Co5 may be electrically coupled to one end of the capacitor Co4.

In the voltage conversion circuit 70 shown in FIG. 5, the ground potential is supplied to each of the other end of the capacitor Co2, the other end of the capacitor Co3, the other end of the capacitor Co4, and the other end of the capacitor Co5, so that the reference potential of each of the capacitors Co2 to Co5 is stabilized. Accordingly, the accuracy of the voltage values of the voltage signals VD2 to VD5 output from one end of a respective one of the capacitors Co2 to Co5 is improved. On the other hand, the other end of the capacitor Co2 is electrically coupled to one end of the capacitor Co1, the other end of the capacitor Co3 is electrically coupled to one end of the capacitor Co2, the other end of the capacitor Co4 is electrically coupled to one end of the capacitor Co3, and the other end of the capacitor Co5 is electrically coupled to one end of the capacitor Co4, so that the capacitance and the withstand voltage of each of the capacitors Co2 to Co5 can be reduced. Accordingly, the capacitors Co2 to Co5 and the voltage conversion circuit 70 can be miniaturized.

### 4. Configuration and Operation of Drive Circuit

Next, a configuration and an operation of the drive circuit 50 will be described.

### 4.1 Signal Waveform of Drive Signal COM

In describing the configuration and the operation of the drive circuit 50, first, an example of the signal waveform of the drive signal COM output by the drive circuit 50 will be described. FIG. 7 is a diagram showing the example of the signal waveform of the drive signal COM. As shown in FIG. 7, the drive signal COM includes a trapezoidal waveform Adp for each cycle T. The trapezoidal waveform Adp includes a period in which the drive signal COM is constant at a voltage vc, a period which follows the period in which the drive signal COM is constant at the voltage vc, and in which the drive signal COM is constant at a voltage vb lower than the voltage vc, a period which follows the period in which the drive signal COM is constant at the voltage vb, and in which the drive signal COM is constant at a voltage vt higher than the voltage vc, and a period which follows the period in which the drive signal COM is constant at the voltage vt, and in which the drive signal COM is constant at the voltage vc. That is, the drive signal COM includes the trapezoidal waveform Adp in which the voltage changes between the voltage vt and the voltage vb and which starts at the voltage vc and ends at the voltage vc in the cycle T.

The voltage vc corresponds to a potential serving as a reference for the displacement of the piezoelectric element 60. When the voltage of the drive signal COM supplied to the piezoelectric element 60 changes from the voltage vc to the voltage vb, the piezoelectric element 60 is driven upward as shown in FIG. 4. As a result, the vibration plate 621 is displaced upward as shown in FIG. 4. Then, when the vibration plate 621 is displaced upward as shown in FIG. 4, the internal volume of the cavity 631 is increased, and the ink is drawn into the cavity 631 from the reservoir 641. Thereafter, when the voltage of the drive signal COM supplied to the piezoelectric element 60 changes from the voltage vb to the voltage vt, the piezoelectric element 60 is driven downward as shown in FIG. 4. As a result, the vibration plate 621 is displaced downward as shown in FIG. 4. When the vibration plate 621 is displaced downward as shown in FIG. 4, the internal volume of the cavity 631 is reduced, and the ink stored in the cavity 631 is ejected from the nozzle 651.

During a constant period after the ink is ejected from the nozzle 651 by driving the piezoelectric element 60, ink near the nozzle 651 and the vibration plate 621 may continue to vibrate. The period in which the drive signal COM is constant at the voltage vc, vt, and vb and which is included in the drive signal COM also functions as a period for stopping such a vibration which is generated in the ink or the vibration plate 621 and does not contribute to the ejection of the ink.

Here, the signal waveform of the drive signal COM shown in FIG. 7 is an example and is not limited thereto, and may include signal waveforms of various shapes depending on physical properties of the ink ejected by the liquid ejection head 21, a length of the cycle T of the drive signal COM, a conveyance speed of the medium P, and the like.

### 4.2 Configuration of Drive Circuit

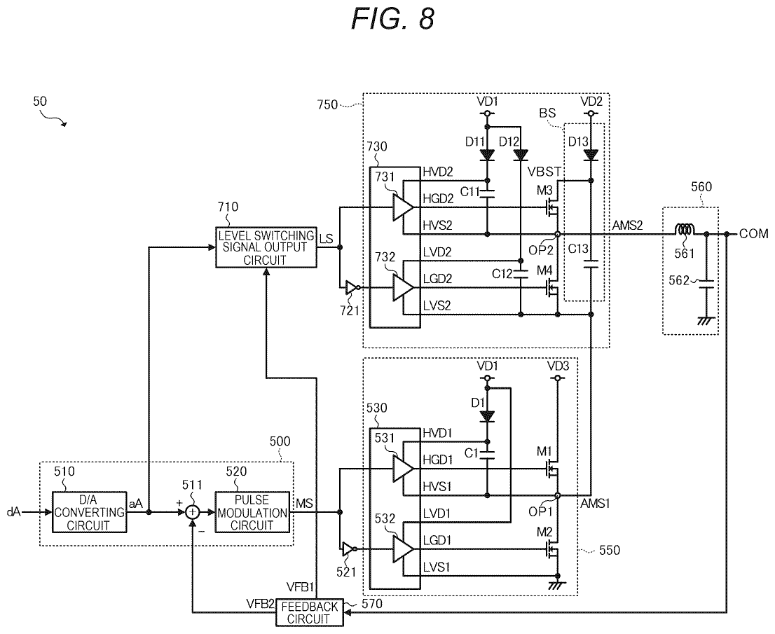

Next, the configuration of the drive circuit 50 will be described. FIG. 8 is a diagram showing an example of a functional configuration of the drive circuit 50. As shown in FIG. 8, the drive circuit 50 includes a D/A conversion circuit 510, an adder 511, a pulse modulation circuit 520, an inverter 521, an amplifier circuit 550, a demodulation circuit 560, a feedback circuit 570, a level switching signal output circuit 710, and a level shift circuit 750.

The base drive signal dA, which is a digital signal, is input from the control circuit 100 to the D/A conversion circuit 510. The D/A conversion circuit 510 performs digital-to-analog conversion on the input base drive signal dA, and then outputs the analog signal obtained by the conversion as a base drive signal aA. A voltage amplitude of the base drive signal aA is, for example, 1 V to 2 V. The drive circuit 50 outputs, as the drive signal COM, a signal obtained by amplifying the base drive signal aA. That is, the base drive signal aA corresponds to a target signal of the drive signal COM having not been amplified.

The base drive signal aA is input to a positive input terminal of the adder 511. A feedback signal VFB2 obtained by feeding back the drive signal COM via the feedback circuit 570 to be described below is input to a negative input terminal of the adder 511. The adder 511 outputs a signal obtained by subtracting the feedback signal VFB2 from the base drive signal aA to the pulse modulation circuit 520.

The pulse modulation circuit 520 performs the pulse modulation on the signal output by the adder 511 to generate a modulation signal MS. The pulse modulation circuit 520 outputs the generated modulation signal MS to the amplifier circuit 550. Such a pulse modulation circuit 520 generates a pulse density modulation signal (PDM signal) obtained by modulating the signal output by the adder 511 with a pulse density modulation (PDM) method, and outputs the PDM signal to the amplifier circuit 550 as the modulation signal MS. Specifically, the pulse modulation circuit 520 compares the voltage of the output signal of the adder 511 with a predetermined reference voltage vref. The pulse modulation circuit 520 generates the modulation signal MS at the H level if the voltage of the output signal of the adder 511 is larger than the reference voltage vref, and generates the modulation signal MS at the L level if the voltage of the output signal of the adder 511 is smaller than the reference voltage vref, and outputs the modulation signal MS to the amplifier circuit 550.

The amplifier circuit 550 includes a gate drive circuit 530, a diode D1, a capacitor C1, and transistors M1 and M2. The amplifier circuit 550 generates a first amplified modulation signal AMS1 obtained by amplifying the input modulation signal MS, and outputs the first amplified modulation signal AMS1 from a first output point OP1.

The gate drive circuit 530 outputs a gate signal HGD1 and a gate signal LGD1 based on the modulation signal MS. Specifically, the modulation signal MS is input to a gate driver 531 provided in the gate drive circuit 530. The gate driver 531 generates the gate signal HGD1 obtained by shifting the level of the modulation signal MS input thereto, and then outputs the gate signal HGD1 to the transistor M1. Further, after a logic level of the modulation signal MS is inverted in the inverter 521, the modulation signal MS is input to a gate driver 532 provided in the gate drive circuit 530. The gate driver 532 generates the gate signal LGD1 obtained by shifting the level of a signal obtained by inverting the logic level of the modulation signal MS input thereto, and then outputs the gate signal LGD1 to the transistor M2.

The transistors M1 and M2 are both implemented as N-channel MOSFETS. The transistor M1 has a source terminal electrically coupled to the first output point OP1, and a drain terminal supplied with the voltage signal VD3, and operates based on the gate signal HGD1 input to a gate terminal thereof. The transistor M2 has a drain terminal electrically coupled to the first output point OP1, and a source terminal supplied with the ground potential, and operates based on the gate signal LGD1 input to a gate terminal thereof. When the transistor M1 operates based on the gate signal HGD1 and the transistor M2 operates based on the gate signal LGD1, the first amplified modulation signal AMS1 obtained by amplifying the modulation signal MS with the voltage vd3 which is a voltage value of the voltage signal VD3 is generated at the first output point OP1.

Here, an operation of the gate drive circuit 530 will be described. The gate drive circuit 530 includes the gate drivers 531 and 532. As described above, the modulation signal MS is input to the gate driver 531, and the signal obtained by inverting the logic level of the modulation signal MS by the inverter 521 is input to the gate driver 532. That is, the signal input to the gate driver 531 and the signal input to the gate driver 532 are exclusively at the H level. Here, being exclusively at the H level includes a case where a signal at the H level is not input to the gate driver 531 and the gate driver 532 at the same time. That is, a case where a signal at the L level is input to the gate driver 531 and the gate driver 532 at the same time is not excluded.

A power supply terminal at a low potential side of the gate driver 531 is electrically coupled to the first output point OP1. Therefore, the first amplified modulation signal AMS1 generated at the first output point OP1 is supplied to the power supply terminal at the low potential side of the gate driver 531 as a voltage signal HVS1. A power supply terminal at a high potential side of the gate driver 531 is electrically coupled to a cathode terminal of the diode D1 and one end of the capacitor C1. An anode terminal of the diode D1 is supplied with the voltage signal VD1, and the other end of the capacitor C1 is electrically coupled to the first output point OP1. That is, the diode D1 and the capacitor C1 form a bootstrap circuit, and an output voltage of the bootstrap circuit is supplied to the power supply terminal at the high potential side of the gate driver 531. Therefore, the power supply terminal at the high potential side of the gate driver 531 is supplied with a voltage signal HVD1 having a voltage value higher by the voltage vd1 than a voltage value of the voltage signal HVS1 input to the power supply terminal at the low potential side of the gate driver 531.

Therefore, the gate driver 531 outputs the gate signal HGD1 based on the voltage signal HVD1 having a voltage value higher by the voltage vd1 than the voltage value of the first output point OP1 when receiving the modulation signal MS at the H level, and the gate driver 531 outputs the gate signal HGD1 based on the voltage signal HVS1 which is a voltage value of the first output point OP1 when receiving the modulation signal MS at the L level. Here, the voltage vd1 is a voltage value at which each of the transistors M1 and M2 and transistors M3 and M4 described below can be driven and is a DC voltage of 8.4 V in the liquid ejection apparatus 1 according to the embodiment as described above.

The ground potential is supplied to the power supply terminal at the low potential side of the gate driver 532 as a voltage signal LVS1. The voltage vd1, which is the voltage value of the voltage signal VD1, is supplied to the power supply terminal at the high potential side of the gate driver 532 as a voltage signal LVD1. Therefore, the gate driver 532 outputs the gate signal LGD1 having a voltage value based on the voltage signal LVD1 having a voltage value of the voltage vd1 when receiving the signal at the H level obtained by inverting the logic level of the modulation signal MS at the L level with the inverter 521, and the gate driver 532 outputs the gate signal LGD1 having a voltage value based on the voltage signal LVS1 of the ground potential when receiving the signal at the L level obtained by inverting the logic level of the modulation signal MS at the H level with the inverter 521. When the transistor M1 operates based on the gate signal HGD1 and the transistor M2 operates based on the gate signal LGD1, the first amplified modulation signal AMS1 obtained by amplifying the modulation signal MS with the voltage vd3 which is a voltage value of the voltage signal VD3 is output from the first output point OP1.

The base drive signal aA and a feedback signal VFB1 output by the feedback circuit 570 described below are input to the level switching signal output circuit 710. The level switching signal output circuit 710 outputs a level switching signal LS having a logic level changing based on the input base drive signal aA and feedback signal VFB1. Specifically, the level switching signal output circuit 710 outputs the level switching signal LS at the H level during a period in which a value of the base drive signal aA is constant and is larger than a predetermined threshold value, outputs the level switching signal LS at the L level during a period in which the value of the base drive signal aA is constant and is smaller than the predetermined threshold value, and outputs the level switching signal LS having a logic level changing based on the base drive signal aA and the feedback signal VFB1 during a period in which the value of the base drive signal aA changes. Here, the details of the configuration and operation of the level switching signal output circuit 710 will be described below.

The level shift circuit 750 includes a gate drive circuit 730, diodes D11 and D12, capacitors C11 and C12, transistors M3 and M4, and a boost circuit BS. The level shift circuit 750 outputs, in accordance with the level switching signal LS input thereto, the first amplified modulation signal AMS1 or a signal obtained by shifting the level of the reference potential of the first amplified modulation signal AMS1 from a second output point OP2 as a second amplified modulation signal AMS2.

The gate drive circuit 730 outputs a gate signal HGD2 and a gate signal LGD2 based on the level switching signal LS. Specifically, the level switching signal LS is input to a gate driver 731 provided in the gate drive circuit 730. The gate driver 731 generates the gate signal HGD2 obtained by shifting the level of the level switching signal LS input thereto, and then outputs the gate signal HGD2 to the transistor M3. A logic level of the level switching signal LS is inverted in the inverter 721, and then the level switching signal LS is input to a gate driver 732 provided in the gate drive circuit 730. The gate driver 732 generates the gate signal LGD2 obtained by shifting the level of a signal obtained by inverting the logic level of the level switching signal LS input thereto, and then outputs the gate signal LGD2 to the transistor M4.

The transistors M3 and M4 are both implemented as N-channel MOSFETS. The transistor M3 has a source terminal electrically coupled to the second output point OP2, and a drain terminal supplied with a voltage signal VBST, and operates based on the gate signal HGD2 input to a gate terminal thereof. The transistor M4 has a drain terminal electrically coupled to the second output point OP2, and a source terminal supplied with the first amplified modulation signal AMS1, and operates based on the gate signal LGD2 input to a gate terminal thereof. When the transistor M3 operates based on the gate signal HGD2 and the transistor M4 operates based on the gate signal LGD2, the first amplified modulation signal AMS1 or a signal obtained by shifting the level of the reference potential of the first amplified modulation signal AMS1 is output from the second output point OP2 as the second amplified modulation signal AMS2.

The boost circuit BS includes a diode D13 and a capacitor C13. The capacitor C13 has one end electrically coupled to the first output point OP1 and supplied with the first amplified modulation signal AMS1, and the other end electrically coupled to the drain terminal of the transistor M3. The voltage signal VD2 is supplied to an anode terminal of the diode D13, and a cathode terminal of the diode D13 is electrically coupled to the other end of the capacitor C13 and the drain terminal of the transistor M3. Although FIG. 8 illustrates a case where the boost circuit BS includes one diode D13, the boost circuit BS may include a plurality of diodes D13 coupled in series. Here, a signal based on a voltage value obtained by subtracting the forward drop voltage of the diode D13 from the voltage vd2 which is the voltage value of the voltage signal VD2 is correctly supplied to the drain terminal of the transistor M3 as the voltage signal VBST, but in the following description, the forward drop voltage of the diode D13 is 0 V.

The boost circuit BS generates the voltage signal VBST obtained by adding the voltage value of the first amplified modulation signal AMS1 to the voltage vd2, which is the voltage value between both ends of the capacitor 13, and outputs the voltage signal VBST to the drain terminal of the transistor M3. In other words, the boost circuit BS generates the voltage signal VBST obtained by shifting the level of the reference potential of the first amplified modulation signal AMS1 by the voltage vd2, which is the voltage value of the voltage signal VD2, and outputs the voltage signal VBST to the drain terminal of the transistor M3.

Here, an operation of the gate drive circuit 730 will be described. The gate drive circuit 730 includes gate drivers 731 and 732. As described above, the level switching signal LS is input to the gate driver 731, and the signal obtained by inverting the logic level of the level switching signal LS by the inverter 721 is input to the gate driver 732. That is, the signal input to the gate driver 731 and the signal input to the gate driver 732 are exclusively at the H level. Here, being exclusively at the H level includes a case where a signal at the H level is not input to the gate driver 731 and the gate driver 732 at the same time. That is, a case where a signal at the L level is input to the gate driver 731 and the gate driver 732 at the same time is not excluded.

A power supply terminal at a low potential side of the gate driver 731 is electrically coupled to the second output point OP2. Therefore, the power supply terminal at the low potential side of the gate driver 731 is supplied with a signal generated at the second output point OP2 as a voltage signal HVS2. A power supply terminal at a high potential side of the gate driver 731 is electrically coupled to a cathode terminal of the diode D11 and one end of the capacitor C11. The voltage signal VD1 is supplied to an anode terminal of the diode D11, and the other end of the capacitor C11 is electrically coupled to the second output point OP2. That is, the diode D11 and the capacitor C11 form a bootstrap circuit, and an output voltage of the bootstrap circuit is supplied to the power supply terminal at the high potential side of the gate driver 731. Therefore, the power supply terminal at the high potential side of the gate driver 731 is supplied with a voltage signal HVD2 having a voltage value higher by the voltage vd1 than a voltage value of the voltage signal HVS2 input to the power supply terminal at the low potential side of the gate driver 731.

Therefore, the gate driver 731 outputs the gate signal HGD2 based on the voltage signal HVD2 having a voltage value higher by the voltage vd1 than the voltage value at the second output point OP2 when receiving the level switching signal LS at the H level, and outputs the gate signal HGD2 based on the voltage signal HVS2, which is the voltage value at the second output point OP2, when receiving the level switching signal LS at the L level.

A power supply terminal at a low potential side of the gate driver 732 is electrically coupled to the first output point OP1. Therefore, the first amplified modulation signal AMS1 output from the first output point OP1 is supplied to the power supply terminal at the low potential side of the gate driver 732 as the voltage signal LVS2. A power supply terminal at a high potential side of the gate driver 732 is electrically coupled to a cathode terminal of the diode D12 and one end of the capacitor C12. The voltage signal VD1 is supplied to an anode terminal of the diode D12, and the other end of the capacitor C12 is electrically coupled to the first output point OP1. That is, the diode D12 and the capacitor C12 form a bootstrap circuit, and an output voltage of the bootstrap circuit is supplied to the power supply terminal at the high potential side of the gate driver 732. Therefore, the power supply terminal at the high potential side of the gate driver 732 is supplied with the voltage signal LVD2 having a voltage value higher by the voltage vd1 than a voltage value of the voltage signal LVS2 input to the power supply terminal at the low potential side of the gate driver 732.

Therefore, the gate driver 732 outputs the gate signal LGD2 based on the voltage signal LVD2 having a voltage value higher by the voltage vd1 than the voltage value at the first output point OP1 when receiving a signal at the H level obtained by inverting the logic level of the level switching signal LS at the L level by the inverter 721, and outputs the gate signal HGD2 based on the voltage signal LVS2, which is the voltage value at the first output point OP1, when receiving a signal at the L level obtained by inverting the logic level of the level switching signal LS at the H level by the inverter 721.

When the level switching signal LS at the L level is input to the level shift circuit 750 configured as described above, the first output point OP1 of the amplifier circuit 550 and the second output point OP2 of the level shift circuit 750 are electrically coupled via the transistor M4. Therefore, when the input level switching signal LS is at the L level, the level shift circuit 750 outputs the first amplified modulation signal AMS1 from the second output point OP2 as the second amplified modulation signal AMS2.

On the other hand, when the level switching signal LS at the H level is input to the level shift circuit 750, the first output point OP1 of the amplifier circuit 550 and the second output point OP2 of the level shift circuit 750 are electrically coupled via the boost circuit BS and the transistor M3. Therefore, when the level switching signal LS is at the H level, the level shift circuit 750 outputs the voltage signal VBST, which is a signal obtained by shifting the level of the reference potential of the first amplified modulation signal AMS1 by the voltage vd2 which is the voltage value of the voltage signal VD2, from the second output point OP2 as the second amplified modulation signal AMS2.

The second amplified modulation signal AMS2 output by the level shift circuit 750 is input to the demodulation circuit 560. The demodulation circuit 560 smooths the second amplified modulation signal AMS2 output by the level shift circuit 750 to demodulate the second amplified modulation signal AMS2 and then outputs the demodulated signal as the drive signal COM.

The demodulation circuit 560 includes an inductor 561 and a capacitor 562. One end of the inductor 561 is electrically coupled to the second output point OP2. The other end of the inductor 561 is electrically coupled to one end of the capacitor 562. The ground potential is supplied to the other end of the capacitor 562. That is, the inductor 561 and the capacitor 562 form a low-pass filter circuit. The second amplified modulation signal AMS2 output from the level shift circuit 750 is smoothed by the low-pass filter circuit. A signal obtained by smoothing the second amplified modulation signal AMS2 is output from the drive circuit 50 as the drive signal COM.

The feedback circuit 570 generates the feedback signal VFB1 corresponding to the drive signal COM generated by the demodulation circuit 560 and outputs the feedback signal VFB1 to the level switching signal output circuit 710. The feedback signal VFB1 output by the feedback circuit 570 is a signal obtained by dividing the drive signal COM by a voltage dividing circuit (not illustrated) and extracting a high-frequency component of a signal obtained by dividing the drive signal COM by a high pass filter (not illustrated) or the like.

The feedback circuit 570 generates the feedback signal VFB2 corresponding to the drive signal COM generated by the demodulation circuit 560 and outputs the feedback signal VFB2 to the adder 511. The feedback signal VFB2 output by the feedback circuit 570 includes a signal obtained by dividing g the drive signal COM or a signal obtained by dividing the drive signal COM by a voltage dividing circuit (not illustrated) and extracting a high-frequency component of the signal obtained by dividing the drive signal COM by a high pass filter (not illustrated) or the like. The adder 511 outputs a signal obtained by subtracting the feedback signal VFB2 from the base drive signal aA to the pulse modulation circuit 520, and the pulse modulation circuit 520 outputs the modulation signal MS based on the feedback signal VFB2 in response to the output of the adder 511. Accordingly, the waveform accuracy of the drive signal COM output by the drive circuit 50 is improved.

Here, in the feedback circuit 570, the voltage dividing circuit for generating the feedback signal VFB2 and the voltage dividing circuit for generating the feedback signal VFB1 may be a common circuit, and the high pass filter for generating the feedback signal VFB2 and the high pass filter for generating the feedback signal VFB1 may be a common circuit.

As described above, the drive circuit 50 according to the embodiment is a so-called capacitive load drive circuit outputting the drive signal COM for driving a capacitive load such as the piezoelectric element 60, and includes: the pulse modulation circuit 520 that modulates the base drive signal aA corresponding to the base drive signal dA serving as a base of the drive signal COM and outputs the modulation signal MS; the amplifier circuit 550 that includes the gate drive circuit 530 for outputting the gate signals HGD1 and LGD1 corresponding to the modulation signal MS and outputs the first amplified modulation signal AMS1 obtained by amplifying the modulation signal MS, the first amplified modulation signal AMS1 corresponding to the gate signals HGD1 and LGD1; the level switching signal output circuit 710 that outputs the level switching signal LS having a voltage value changing between the L level and the H level; the level shift circuit 750 that outputs the first amplified modulation signal AMS1 as the second amplified modulation signal AMS2 when the level switching signal LS is at the L level, and that outputs a signal obtained by shifting the level of the reference potential of the first amplified modulation signal AMS1 as the second amplified modulation signal AMS2 when the level switching signal LS is at the H level; the demodulation circuit 560 that demodulates the second amplified modulation signal AMS2 and outputs the drive signal COM; and the feedback circuit 570 that outputs the feedback signal VFB1 corresponding to the drive signal COM.

At least one of the voltage signal VD1 and the voltage signal VD2, that is, both the voltage signal VD1 and the voltage signal VD2 are supplied to the drive circuit 50 according to the embodiment. Specifically, among the voltage signals VD1 to VD5 output by the voltage conversion circuit 70, the voltage signal VD1 is supplied to the gate drive circuit 530 and the gate drive circuit 730, the voltage signal VD3 is supplied to the amplifier circuit 550, and the voltage signal VD2 is supplied to the level shift circuit 750.

Here, a signal supplied to the drain terminal of the transistor M1 of the amplifier circuit 550, which is a signal output by the voltage conversion circuit 70 and input to the amplifier circuit 550, is not limited to the voltage signal VD3, and may be any of the voltage signals VD1 to VD5. A signal supplied to the boost circuit BS of the level shift circuit 750, which is a signal output by the voltage conversion circuit 70 and input to the level shift circuit 750, is not limited to the voltage signal VD2, and may be any of the voltage signals VD1 to VD5. However, as shown in the liquid ejection apparatus 1 according to the embodiment, a voltage value of the signal supplied to the drain terminal of the transistor M1 of the amplifier circuit 550 is preferably equal to or greater than a voltage value of the signal supplied to the boost circuit BS of the level shift circuit 750. That is, when the voltage signal VDi is supplied to the drain terminal of the transistor M1 of the amplifier circuit 550, any one of the voltage signals VD1 to VDi is preferably supplied to the boost circuit BS of the level shift circuit 750.

In this case, it is more preferable that the value of the base drive signal aA corresponding to the predetermined threshold value used for switching of whether the level switching signal output circuit 710 outputs the level switching signal LS at the L level or outputs the level switching signal LS at the H level is equal to or less than a value of the base drive signal aA when the voltage value of the drive signal COM is the voltage value of the signal supplied to the drain terminal of the transistor M1 of the amplifier circuit 550, and is equal to or greater than a value of the base drive signal aA when the voltage value of the drive signal COM is the voltage value of the signal supplied to the boost circuit BS of the level shift circuit 750.

When the level switching signal output circuit 710 outputs the level switching signal LS at the L level, that is, the level shift circuit 750 outputs the first amplified modulation signal AMS1 as the second amplified modulation signal AMS2, the voltage value of the drive signal COM output by the drive circuit 50 changes between the ground potential and the voltage value of the signal supplied to the drain terminal of the transistor M1 of the amplifier circuit 550. In contrast, when the level switching signal output circuit 710 outputs the level switching signal LS at the H level, that is, the level shift circuit 750 outputs the signal obtained by shifting the level of the reference potential of the first amplified modulation signal AMS1 as the second amplified modulation signal AMS2, the voltage value of the drive signal COM output by the drive circuit 50 changes between the voltage value of the signal supplied to the boost circuit BS of the level shift circuit 750 and the voltage value obtained by adding the voltage value of the signal supplied to the boost circuit BS of the level shift circuit 750 to the voltage value of the signal supplied to the drain terminal of the transistor M1 of the amplifier circuit 550.

In such a liquid ejection apparatus 1, the voltage value of the signal supplied to the drain terminal of the transistor M1 of the amplifier circuit 550 is set to be equal to or greater than the voltage value of the signal supplied to the boost circuit BS of the level shift circuit 750, and the value of the base drive signal aA corresponding to the predetermined threshold value for switching whether the level switching signal output circuit 710 outputs the level switching signal LS at the L level or outputs the level switching signal LS at the H level is equal to or less than the value of the base drive signal aA when the voltage value of the drive signal COM is a voltage value of the signal supplied to the drain terminal of the transistor M1 of the amplifier circuit 550, and is equal to or greater than the value of the base drive signal aA when the voltage value of the drive signal COM is the voltage value of the signal supplied to the boost circuit BS of the level shift circuit 750, so that a part of a voltage range of the drive signal COM that can be output by the drive circuit 50 during a period in which the level switching signal output circuit 710 outputs the level switching signal LS at the L level overlaps a part of a voltage range of the drive signal COM that can be output by the drive circuit 50 during a period in which the level switching signal output circuit 710 outputs the level switching signal LS at the H level.

Accordingly, the drive circuit 50 can continuously control the voltage value of the drive signal COM in a range from the ground potential to a voltage value obtained by adding the voltage value of the signal supplied to the boost circuit BS of the level shift circuit 750 to the voltage value of the signal supplied to the drain terminal of the transistor M1 of the amplifier circuit 550. As a result, the waveform accuracy of the signal waveform of the drive signal COM output by the drive circuit 50 is improved.

Further, it is preferable that the maximum voltage value that can be output as the drive signal COM by the drive circuit 50, which is a voltage value obtained by adding the voltage value of the signal supplied to the boost circuit BS of the level shift circuit 750 to the voltage value of the signal supplied to the drain terminal of the transistor M1 of the amplifier circuit 550, is equal to or less than the voltage vd5 that is the voltage value of the voltage signal VD5 input to the selection control circuit 200.

As described above, the drive signal COM output by the drive circuit 50 is input to the plurality of selection units 230. Each of the plurality of selection units 230 generates the drive signal VOUT by selecting or not selecting the input drive signal COM based on the selection signal S converted into a high amplitude logic signal based on the voltage vd5 output by the selection control unit 210, and outputs the drive signal VOUT to the corresponding ejection unit 600. In such a liquid ejection apparatus 1, when the maximum voltage value that can be output as the drive signal COM by the drive circuit 50 is set to be smaller than the voltage vd5 that defines the logic level of the selection signal S, it is possible to perform the operation of selecting or not selecting the drive signal COM in each of the plurality of selection units 230 without exceeding the withstand voltage of the selection control circuit 200. That is, as shown in the drive circuit 50 according to the embodiment, when a sum of the voltage vd3, which is the voltage value of the voltage signal VD3 supplied to the drain terminal of the transistor M1 of the amplifier circuit 550, and the voltage vd2, which is the voltage value of the voltage signal VD2 supplied to the boost circuit BS of the level shift circuit 750 is set to be equal to or less than the voltage vd5 which is the voltage value of the voltage signal VD5 input to the selection control circuit 200, the drive signal VOUT is supplied to the ejection unit 600, and as a result, the ink can be ejected from the ejection unit 600.

Here, in the following description, when the level switching signal output circuit 710 outputs the level switching signal LS of the L level, an operation mode of the drive circuit 50 during a period in which the level shift circuit 750 outputs the first amplified modulation signal AMS1 as the second amplified modulation signal AMS2 and the value of the base drive signal aA is constant may be referred to as a first mode MD1. When the level switching signal output circuit 710 outputs the level switching signal LS at the H level, an operation mode of the drive circuit 50 during a period in which the level shift circuit 750 outputs the signal obtained by shifting the level of the reference potential of the first amplified modulation signal AMS1 as the second amplified modulation signal AMS2 and the value of the base drive signal aA is constant may be referred to as a second mode MD2. An operation mode of the drive circuit 50 during a period in which the value of the base drive signal aA changes, regardless of the logic level of the level switching signal LS output by the level switching signal output circuit 710, may be referred to as a third mode MD3.

As described above, when the value of the base drive signal aA is smaller than the predetermined threshold value, the level switching signal output circuit 710 outputs the level switching signal LS at the L level, and when the value of the base drive signal aA is larger than the predetermined threshold value, the level switching signal output circuit 710 outputs the level switching signal LS at the H level. That is, the first mode MD1 corresponds to an operation mode of the drive circuit 50 when the value of the base drive signal aA is smaller than the predetermined threshold value and constant, the second mode MD2 corresponds to the operation mode of the drive circuit 50 when the value of the base drive signal aA is larger than the predetermined threshold value and constant, and the third mode MD3 corresponds to the operation mode of the drive circuit 50 when the value of the base drive signal aA changes.

### 4.3 Operation of Drive Circuit

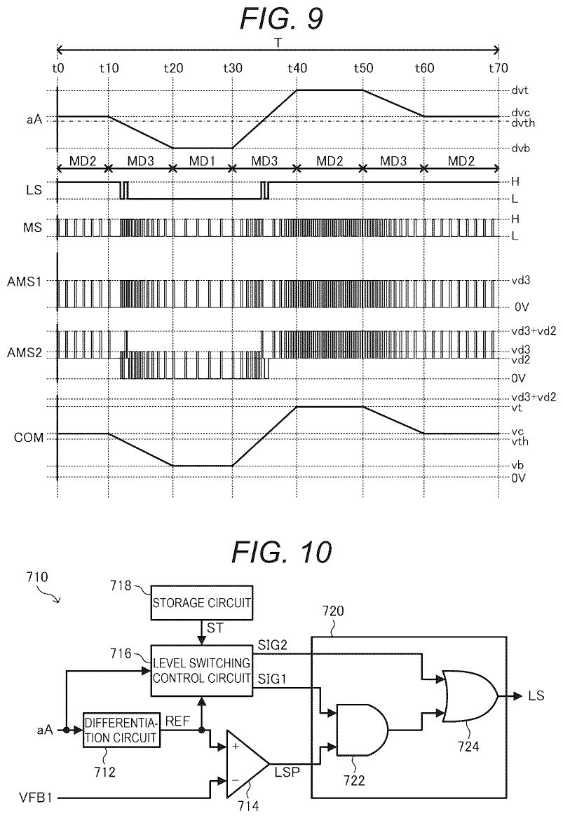

Next, the operation of the drive circuit 50 will be described. FIG. 9 is a diagram illustrating the operation of the drive circuit 50. Note that FIG. 9 illustrates only the drive signal COM in any cycle T in the drive signal COM output by the drive circuit 50. For convenience of illustration and description, FIG. 9 illustrates a signal waveform in an ideal case without a circuit delay or a wiring delay. FIG. 9 illustrates a threshold value dvth of the base drive signal aA for switching the logic level of the level switching signal LS output by the level switching signal output circuit 710, and illustrates the voltage value of the drive signal COM corresponding to the threshold value dvth as the voltage vth. In FIG. 9, the values of the base drive signal aA corresponding to the voltages vt, vb, and vc, which are the voltage values of the drive signal COM, are illustrated as voltages dvt, dvb, and dvc, respectively. FIG. 9 illustrates a case where the voltage vth is lower than the voltage vc and the threshold value dvth is lower than the voltage dvc, and the voltage vth may be higher than the voltage vc and the threshold value dvth may be higher than the voltage dvc.

As shown in FIG. 9, during a period from a time point t0 to a time point t10, the D/A conversion circuit 510 outputs, in response to the input base drive signal dA, the base drive signal aA having a voltage value larger than the threshold value dvth and constant at the voltage dvc, and the drive circuit 50 outputs, in response to the base drive signal dA and the base drive signal aA, the drive signal COM having a voltage value larger than the voltage vth and constant at the voltage vc. That is, during the period from the time point t0 to the time point t10, an operation mode of the drive circuit 50 is the second mode MD2.

During a period from a time point t10 to a time point t20, the D/A conversion circuit 510 outputs, in response to the input base drive signal dA, the base drive signal aA having a changing value, which has a voltage value changing from the voltage dvc to the voltage dvb lower than the threshold value dvth, and the drive circuit 50 outputs, in response to the base drive signal dA and the base drive signal aA, the drive signal COM having a voltage value changing from the voltage vc to the voltage vb lower than the voltage vth. That is, during the period from the time point t10 to the time point t20, the operation mode of the drive circuit 50 is the third mode MD3.

During a period from the time point t20 to a time point t30, the D/A conversion circuit 510 outputs, in response to the input base drive signal dA, the base drive signal aA having a voltage value smaller than the threshold value dvth and constant at the voltage dvb, and the drive circuit 50 outputs, in response to the base drive signal dA and the base drive signal aA, the drive signal COM having a voltage value smaller than the voltage vth and constant at the voltage vb. That is, during the period from the time point t20 to the time point t30, the operation mode of the drive circuit 50 is the first mode MD1.

During a period from the time point t30 to a time point t40, the D/A conversion circuit 510 outputs, in response to the input base drive signal dA, the base drive signal aA having a changing value, which has a voltage value changing from the voltage dvb to the voltage dvt exceeding the threshold value dvth, and the drive circuit 50 outputs, in response to the base drive signal dA and the base drive signal aA, the drive signal COM having a voltage value changing from the voltage vb to the voltage vt exceeding the voltage vth. That is, during the period from the time point t30 to the time point t40, the operation mode of the drive circuit 50 is the third mode MD3.

During a period from the time point t40 to a time point t50, the D/A conversion circuit 510 outputs, in response to the input base drive signal dA, the base drive signal aA having a voltage value larger than the threshold value dvth and constant at the voltage dvt, and the drive circuit 50 outputs, in response to the base drive signal dA and the base drive signal aA, the drive signal COM having a voltage value larger than the voltage vth and constant at the voltage vt. That is, during the period from the time point t40 to the time point t50, the operation mode of the drive circuit 50 is the second mode MD2.

During a period from the time point t50 to a time point t60, the D/A conversion circuit 510 outputs, in response to the input base drive signal dA, the base drive signal aA having a changing value, which has a voltage value changing from the voltage dvt to the voltage dvc, and the drive circuit 50 outputs, in response to the base drive signal dA and the base drive signal aA, the drive signal COM having a voltage value changing from the voltage vt to the voltage vc. That is, during the period from the time point t50 to the time point t60, the operation mode of the drive circuit 50 is the third mode MD3.

During a period from the time point t60 to a time point t70, the D/A conversion circuit 510 outputs, in response to the input base drive signal dA, the base drive signal aA having a voltage value larger than the threshold value dvth and constant at the voltage dvc, and the drive circuit 50 outputs, in response to the base drive signal dA and the base drive signal aA, the drive signal COM having a voltage value larger than the voltage vth and constant at the voltage vc. That is, during the period from the time point t60 to the time point t70, the operation mode of the drive circuit 50 is the second mode MD2.

Here, the time point t70 corresponds to the time point to described above. That is, the period from the time point t0 to the time point t70 corresponds to the cycle T. As shown in FIG. 9, the operation mode of the drive circuit 50 is switched to the first mode MD1, the second mode MD2, and the third mode MD3 in response to the input base drive signals dA and aA.

Here, an operation of the drive circuit 50 in each operation mode will be described.

In the first mode MD1, the D/A conversion circuit 510 outputs the base drive signal aA having a constant voltage value smaller than the threshold value dvth. At this time, the pulse modulation circuit 520 outputs the modulation signal MS having a substantially constant duty ratio because the voltage value of the input base drive signal aA is constant and the voltage value of the drive signal COM output by the drive circuit 50 is constant. Therefore, the amplifier circuit 550 generates and outputs the first amplified modulation signal AMS1 which is obtained by amplifying the modulation signal MS based on the voltage vd3 and has a substantially constant duty ratio.

In the first mode MD1, the level switching signal output circuit 710 outputs the level switching signal LS at the L level because the D/A conversion circuit 510 outputs the base drive signal aA having a constant voltage value smaller than the threshold value dvth. Therefore, the level shift circuit 750 outputs the first amplified modulation signal AMS1 as the second amplified modulation signal AMS2. That is, in the first mode MD1, the level shift circuit 750 outputs the first amplified modulation signal AMS1 having a substantially constant duty ratio as the second amplified modulation signal AMS2. The second amplified modulation signal AMS2 output by the level shift circuit 750 is smoothed by the demodulation circuit 560, so that the drive circuit 50 outputs the drive signal COM having a constant voltage value smaller than the voltage vth in the first mode MD1.

In the second mode MD2, the D/A conversion circuit 510 outputs the base drive signal aA having a constant voltage value larger than the threshold value dvth. At this time, the pulse modulation circuit 520 outputs the modulation signal MS having a substantially constant duty ratio because the voltage value of the input base drive signal aA is constant and the voltage value of the drive signal COM output by the drive circuit 50 is constant. Therefore, the amplifier circuit 550 generates and outputs the first amplified modulation signal AMS1 which is obtained by amplifying the modulation signal MS based on the voltage vd3 and has a substantially constant duty ratio.

In the second mode MD2, the level switching signal output circuit 710 outputs the level switching signal LS at the H level because the D/A conversion circuit 510 outputs the base drive signal aA having a constant voltage value larger than the threshold value dvth. Therefore, the level shift circuit 750 outputs, as the second amplified modulation signal AMS2, a signal obtained by shifting the level of the reference potential of the first amplified modulation signal AMS1 by the voltage vd2. That is, in the second mode MD2, the level shift circuit 750 outputs, as the second amplified modulation signal AMS2, a signal obtained by shifting the level of the reference potential of the first amplified modulation signal AMS1 having a substantially constant duty ratio from the ground potential to the voltage vd2. The second amplified modulation signal AMS2 output by the level shift circuit 750 is smoothed by the demodulation circuit 560, so that the drive circuit 50 outputs the drive signal COM having a constant voltage value larger than the voltage vth in the second mode MD2.

In the third mode MD3, the D/A conversion circuit 510 outputs the base drive signal aA having a changing voltage value. At this time, the pulse modulation circuit 520 outputs the modulation signal MS having a duty ratio changing based on a difference between a voltage value of the input changing base drive signal aA and the feedback signal VFB2 corresponding to the drive signal COM output by the drive circuit 50. Therefore, the amplifier circuit 550 amplifies the modulation signal MS based on the voltage vd3 to generate and output the first amplified modulation signal AMS1 having a duty ratio changing based on the difference between the changing voltage value of the base drive signal aA and the feedback signal VFB2.

In the third mode MD3 in which the voltage value of the base drive signal aA changes, when both a voltage value of the base drive signal aA before the change and a voltage value of the base drive signal aA after the change are smaller than the threshold value dvth, the level switching signal output circuit 710 may continue to output the level switching signal LS at the L level. At this time, the level shift circuit 750 outputs, as the second amplified modulation signal AMS2, the first amplified modulation signal AMS1 having a duty ratio changing in response to the change in the base drive signal aA. The second amplified modulation signal AMS2 output by the level shift circuit 750 is smoothed by the demodulation circuit 560, so that the drive circuit 50 outputs the drive signal COM having a voltage value changing while being smaller than the voltage vth in response to the change in the voltage value of the base drive signal aA. In the third mode MD3 in which the voltage value of the base drive signal aA changes, when both the voltage value of the base drive signal aA before the change and the voltage value of the base drive signal aA after the change are smaller than the threshold value dvth, the level switching signal output circuit 710 may output the level switching signal LS having a logic level changing based on the base drive signal aA and the feedback signal VFB1.

In the third mode MD3 in which the voltage value of the base drive signal aA changes, when both the voltage value of the base drive signal aA before the change and the voltage value of the base drive signal aA after the change are larger than the threshold value dvth, the level switching signal output circuit 710 continues to output the level switching signal LS at the H level. At this time, the level shift circuit 750 outputs, as the second amplified modulation signal AMS2, a signal obtained by shifting the level of the reference potential of the first amplified modulation signal AMS1 having a duty ratio changing by the voltage vd2 in response to the change in the base drive signal aA. The second amplified modulation signal AMS2 output by the level shift circuit 750 is smoothed by the demodulation circuit 560, so that the drive circuit 50 outputs the drive signal COM having a voltage value changing while being larger than the voltage vth in response to the change in the voltage value of the base drive signal aA. In the third mode MD3 in which the voltage value of the base drive signal aA changes, when both the voltage value of the base drive signal aA before the change and the voltage value of the base drive signal aA after the change are larger than the threshold value dvth, the level switching signal output circuit 710 may output the level switching signal LS having a logic level changing based on the base drive signal aA and the feedback signal VFB1.

In the third mode MD3 in which the voltage value of the base drive signal aA changes, when the voltage value of the base drive signal aA before the change is smaller than the threshold value dvth and the voltage value of the base drive signal aA after the change is larger than the threshold value dvth, and when the voltage value of the base drive signal aA before the change is larger than the threshold value dvth and the voltage value of the base drive signal aA after the change is smaller than the threshold value dvth, that is, when the voltage value of the base drive signal aA changes across the threshold value dvth, the level switching signal output circuit 710 outputs the level switching signal LS having a logic level changing based on the base drive signal aA and the feedback signal VFB1. At this time, the level shift circuit 750 outputs the second amplified modulation signal AMS2 in which the reference potential of the first amplified modulation signal AMS1 having a duty ratio changing in response to the change in the base drive signal aA changes between the ground potential and the voltage vd2 based on the base drive signal aA and the feedback signal VFB1. The second amplified modulation signal AMS2 output by the level shift circuit 750 is smoothed by the demodulation circuit 560, so that the drive circuit 50 outputs the drive signal COM having a voltage value changing across the voltage vth in response to the change in the voltage value of the base drive signal aA.

When the voltage value of the base drive signal aA changes across the threshold value dvth, and the level switching signal output circuit 710 changes the logic level of the output level switching signal LS according to only a comparison result between the value of the base drive signal aA and the threshold value dvth, the reference potential of the second amplified modulation signal AMS2 output by the level shift circuit 750 steeply changes from the ground potential to the voltage vd2 or from the voltage vd2 to the ground potential. When the response speed of the drive circuit 50 cannot follow the steep change in the reference potential, distortion may occur in the signal waveform of the drive signal COM, and the waveform accuracy of the drive signal COM may deteriorate.

In contrast, in the drive circuit 50 according to the embodiment, the level switching signal output circuit 710 generates the level switching signal LS using the base drive signal aA and the feedback signal VFB2 obtained by feeding back the drive signal COM, so that the possibility that the reference potential of the second amplified modulation signal AMS2 output by the level shift circuit 750 steeply changes is reduced, and the possibility that the waveform accuracy of the drive signal COM deteriorates is reduced.

### 4.4 Configuration and Operation of Level Switching Signal

### Output Circuit

FIG. 10 is a diagram showing an example of a configuration of the level switching signal output circuit 710. As shown in FIG. 10, the level switching signal output circuit 710 includes a differentiation circuit 712, a comparison circuit 714, a level switching control circuit 716, a storage circuit 718, and an output switching circuit 720.

The base drive signal aA is input to the differentiation circuit 712. The differentiation circuit 712 outputs a signal obtained by differentiating the input base drive signal aA, which is a signal corresponding to a temporal change in the voltage value of the input base drive signal aA, to the comparison circuit 714 as the reference signal REF. Such a differentiation circuit 712 may include a capacitor element and a resistive element, or may include an operational amplifier or the like.

The comparison circuit 714 includes, for example, a comparing unit such as a comparator. The reference signal REF output from the differentiation circuit 712 is input to a positive input terminal of the comparison circuit 714. The feedback input to a negative input terminal of the comparison circuit 714. The comparison circuit 714 compares a voltage value of the reference signal REF with a voltage value of the feedback signal VFB1. The comparison circuit 714 generates a pulse signal LSP at the H level when the voltage value of the reference signal REF is larger than the voltage value of the feedback signal VFB1, and generates a pulse signal LSP at the L level when the voltage value of the reference signal REF is smaller than the voltage value of the feedback signal VFB1, and outputs the pulse signal LSP to the output switching circuit 720.

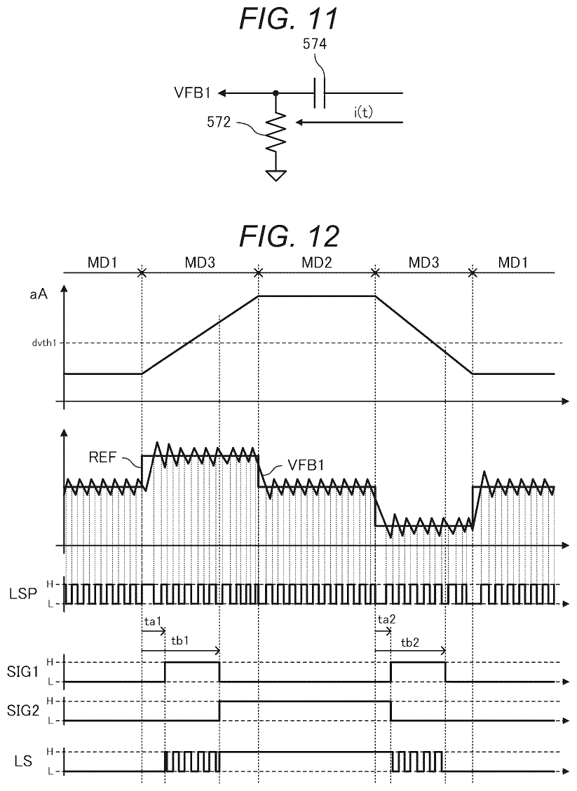

Here, a relation between the reference signal REF and the feedback signal VFB1 input to the comparison circuit 714 will be described. FIG. 11 is a diagram showing an example of a configuration of the high pass filter provided in the feedback circuit 570. As shown in FIG. 11, the high pass filter provided in the feedback circuit 570 includes a resistor 572 and a capacitor 574. A signal obtained by dividing the voltage value of the drive signal COM is input to the high pass filter. In the high pass filter, when the capacitance of the capacitor 574 is set as a capacitance value C, a resistance value of the resistor 572 is set as a resistance value R, and a current i(t) flows through the capacitor 574, a proportional relation is established between the drive signal COM and the base drive signal aA when the voltage vfb1, which is the voltage value of the feedback signal VFB1, satisfies the formula (1). Here, in the formula (1), α represents a constant, and v(t) represents a voltage value of the base drive signal aA.

$$Math . 1$$

$$v fb 1 = i ( t ) \cdot R = α RC \frac{v ( t )}{dt} ( 1 - {e}^{- \frac{1}{RC} t} ) \qquad ( 1 )$$

In such a high pass filter, when a product RC of the resistance value R and the capacitance value C is sufficiently smaller than the time tx during which the voltage v(t) changes, the feedback signal VFB1 can be regarded as a signal including a so-called rectangular wave in which the voltage vfb1 corresponding to the change amount of the voltage v(t) occurs when the voltage v(t) which is the voltage value of the base drive signal aA changes. Here, the product RC of the resistance value R and the capacitance value C being sufficiently smaller than the time tx during which the voltage v(t) changes includes, for example, a case where the product RC is 100×10⁻⁹ or less when the time tx is about 1 μs.

When the voltage value of the rectangular wave based on the feedback signal VFB1 obtained by making the product RC of the resistance value R and the capacitance value C sufficiently smaller than the time tx during which the voltage v(t) changes is set as the voltage vb, the voltage vb can be expressed as the formula (2). Here, in the formula (2), the voltage va is a change amount of the voltage of the base drive signal aA in the time tx.

$$Math . 2$$

$$v b = α RC \frac{v a}{tx} \qquad ( 2 )$$

That is, the feedback signal VFB1 can be regarded as a rectangular wave by making the product RC of the resistance value R and the capacitance value C sufficiently smaller than the time tx during which the voltage v(t) changes. The voltage vb which is a voltage value of the rectangular wave is proportional to the voltage va which is a change amount of the voltage of the base drive signal aA in the time tx. Therefore, the reference signal REF, which is a signal corresponding to the temporal change of the voltage value of the base drive signal aA output by the differentiation circuit 712 and is a signal obtained by differentiating the base drive signal aA, is proportional to the feedback signal VFB1.

The comparison circuit 714 compares the voltage value of the reference signal REF with the voltage value of the feedback signal VFB1 in consideration of a proportionality coefficient, and outputs the pulse signal LSP having a logic level corresponding to the comparison result. Here, considering the proportionality coefficient between the voltage value of the reference signal REF and the voltage value of the feedback signal VFB1 means that, based on the proportionality coefficient, at least one of the voltage value of the reference signal REF and the voltage value of the feedback signal VFB1 corresponding to the voltage value of the reference signal REF may be corrected, or a voltage division ratio of the drive signal COM in the feedback circuit 570 may be adjusted.

Returning to FIG. 10, the storage circuit 718 stores timing information ST that defines a switching timing of logic levels of level switching control signals SIG1 and SIG2 output by the level switching control circuit 716 described below.

The reference signal REF and the base drive signal aA are input to the level switching control circuit 716. The level switching control circuit 716 acquires the timing information ST from the storage circuit 718. The level switching control circuit 716 determines, based on the input reference signal REF and base drive signal aA, the operation mode of the drive circuit 50 by determining whether the value of the base drive signal aA is larger or smaller than a predetermined threshold value and whether the value of the base drive signal aA is constant or changes. The level switching control circuit 716 generates the level switching control signals SIG1 and SIG2 having logic levels switched based on the determined operation mode of the drive circuit 50 and the acquired timing information ST, and outputs the level switching control signals SIG1 and SIG2 to the output switching circuit 720.

The output switching circuit 720 includes an AND circuit 722 and an OR circuit 724. The level switching control signals SIG1 and SIG2 and the pulse signal LSP are input to the output switching circuit 720. The output switching circuit 720 generates the level switching signal LS corresponding to the level switching control signals SIG1 and SIG2 and the pulse signal LSP, and outputs the level switching signal LS to the level shift circuit 750.

The level switching control signal SIG1 and the pulse signal LSP are input to the AND circuit 722. The AND circuit 722 outputs a signal at the L level when the logic level of the level switching control signal SIG1 is the L level, and outputs a signal having a logic level switched according to the pulse signal LSP when the logic level of the level switching control signal SIG1 is the H level.

The level switching control signal SIG2 and the output signal of the AND circuit 722 are input to the OR circuit 724. The OR circuit 724 outputs an output signal of the AND circuit 722 when the logic level of the level switching control signal SIG2 is the L level, and outputs a signal at the L level when the logic level of the level switching control signal SIG2 is the L level. The signal output from the OR circuit 724 is output from the level switching signal output circuit 710 as the level switching signal LS.

That is, the output switching circuit 720 outputs the level switching signal LS at the H level regardless of the logic level of the level switching control signal SIG1 when the logic level of the level switching control signal SIG2 is the H level, outputs the level switching signal LS at the L level when the logic level of the level switching control signal SIG2 is the L level and the logic level of the level switching control signal SIG1 is the L level, and outputs the pulse signal LSP as the level switching signal LS when the logic level of the level switching control signal SIG2 is the L level and the logic level of the level switching control signal SIG1 is the H level.

As described above, the level switching signal output circuit 710 includes: the level switching control circuit 716 that outputs, in response to the base drive signal aA, the level switching control signal SIG1 and the level switching control signal SIG2 for controlling the switching of the potential of the level switching signal LS; the differentiation circuit 712 that outputs the reference signal REF corresponding to the base drive signal aA; the comparison circuit 714 that compares the reference signal REF with the feedback signal VFB1 and outputs the pulse signal LSP corresponding to the comparison result; the output switching circuit 720 that switches, according to the logic level of the level switching control signal SIG1 and the logic level of the level switching control signal SIG2, whether to output the level switching signal LS constant at the L level, output the level switching signal LS constant at the H level, or output the level switching signal LS changing between the L level and the H level according to a pulse signal LSP; and the storage circuit 718 in which the timing information ST is stored.

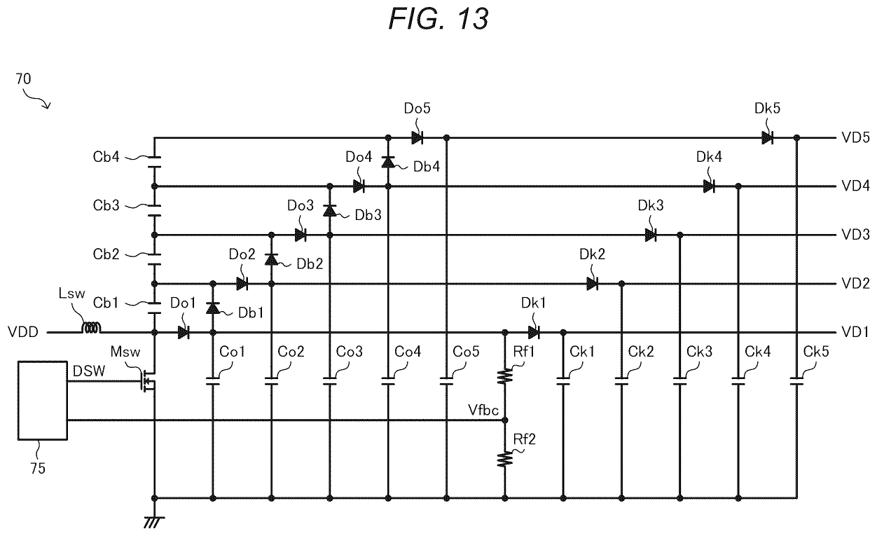

Here, an operation of the level switching signal output circuit 710 will be described. FIG. 12 is a diagram illustrating the operation of the level switching signal output circuit 710. FIG. 12 illustrates the operation of the level switching signal output circuit 710 when the operation mode of the drive circuit 50 transitions from the first mode MD1 to the second mode MD2 or from the second mode MD2 to the first mode MD1 before and after the third mode MD3, which is an example of the operation of the level switching signal output circuit 710 when the voltage value of the base drive signal aA changes across the threshold value dvth in the third mode MD3.

The comparison circuit 714 compares the voltage value of the reference signal REF with the voltage value of the feedback signal VFB1. The comparison circuit 714 outputs the pulse signal LSP at the H level when the voltage value of the reference signal REF is higher than the voltage value of the feedback signal VFB1, and outputs the pulse signal LSP at the L level when the voltage value of the reference signal REF is lower than the voltage value of the feedback signal VFB1.

When the operation mode of the drive circuit 50 transitions from the first mode MD1 to the second mode MD2 or from the second mode MD2 to the first mode MD1 before and after the third mode MD3, the level switching control circuit 716 acquires, as the timing information ST from the storage circuit 718, the time measurement times ta1 and ta2 defining a timing for controlling the logic level of the level switching control signal SIG1 and the time measurement times tb1 and tb2 defining a timing for controlling the logic level of the level switching control signal SIG2. Then, the level switching control circuit 716 outputs the level switching control signals SIG1 and SIG2 having logic levels changing according to the acquired time measurement times ta1, ta2, tb1, and tb2, the input reference signal REF, and the input base drive signal aA.

Specifically, when the operation mode of the drive circuit 50 transitions from the first mode MD1 to the second mode MD2 before and after the third mode MD3, the voltage value of the base drive signal aA increases. The level switching control circuit 716 detects that the operation mode of the drive circuit 50 transitioned from the first mode MD1 to the third mode MD3 by detecting a rising edge of the reference signal REF, which is an increase in the voltage value of the base drive signal aA. Then, the level switching control circuit 716 starts a measurement of the elapsed time after the transition of the operation mode of the drive circuit 50 to the third mode MD3.

The level switching control circuit 716 detects a voltage value of the base drive signal aA immediately before or immediately after the operation mode of the drive circuit 50 transitions from the first mode MD1 to the third mode MD3. At this time, the voltage value of the base drive signal aA is smaller than the threshold value dvth because the operation mode of the drive circuit 50 is the first mode MD1 or immediately after the transition from the first mode MD1 to the third mode MD3. When the voltage value of the base drive signal aA is smaller than the threshold value dvth, the level switching control circuit 716 sets the logic level of the level switching control signal SIG1 as the L level and sets the logic level of the level switching control signal SIG2 as the L level. Therefore, the output switching circuit 720 outputs the level switching signal LS at the L level.

Thereafter, when the elapsed time after the transition of the operation mode of the drive circuit 50 measured by the level switching control circuit 716 to the third mode MD3 reaches the time measurement time ta1, the level switching control circuit 716 sets the logic level of the level switching control signal SIG1 as the H level. At this time, the logic level of the level switching control signal SIG2 output by the level switching control circuit 716 continues to be the L level. Therefore, the output switching circuit 720 outputs, as the level switching signal LS, the pulse signal LSP output by the comparison circuit 714.

Then, when the elapsed time after the transition of the operation mode of the drive circuit 50 measured by the level switching control circuit 716 to the third mode MD3 reaches the time measurement time tb1, the level switching control circuit 716 detects the voltage value of the base drive signal aA. Here, the time measurement time tb1 is set to be longer than the time from the time point when the operation mode of the drive circuit 50 transitions to the third mode MD3 to a time point when the voltage value of the base drive signal aA is larger than the threshold value dvth. Therefore, during the time measurement time tb1, the voltage value of the base drive signal aA detected by the level switching control circuit 716 is larger than the threshold value dvth. When the voltage value of the base drive signal aA is larger than the threshold value dvth, the level switching control circuit 716 sets the logic level of the level switching control signal SIG1 to the L level and sets the logic level of the level switching control signal SIG2 to the H level. Therefore, the output switching circuit 720 outputs the level switching signal LS at the H level.

Thereafter, when the voltage value of the base drive signal aA reaches a predetermined voltage value, the voltage value of the base drive signal aA becomes constant. Accordingly, the operation mode of the drive circuit 50 transitions from the third mode MD3 to the second mode MD2.

When the operation mode of the drive circuit 50 transitions from the second mode MD2 to the first mode MD1 before and after the third mode MD3, the voltage value of the base drive signal aA decreases. The level switching control circuit 716 detects that the operation mode of the drive circuit 50 transitioned from the second mode MD2 to the third mode MD3 by detecting a falling edge of the reference signal REF, which is a decrease in the voltage value of the base drive signal aA. Then, the level switching control circuit 716 starts a measurement of the elapsed time after the transition of the operation mode of the drive circuit 50 to the third mode MD3.

The level switching control circuit 716 detects a voltage value of the base drive signal aA immediately before or immediately after the operation mode of the drive circuit 50 transitions from the second mode MD2 to the third mode MD3. At this time, the voltage value of the base drive signal aA is larger than the threshold value dvth because the operation mode of the drive circuit 50 is the second mode MD2 or immediately after the transition from the second mode MD2 to the third mode MD3. The level switching control circuit 716 sets the logic level of the level switching control signal SIG1 to the L level and sets the logic level of the level switching control signal SIG2 to the H level because the voltage value of the base drive signal aA is larger than the threshold value dvth. Therefore, the output switching circuit 720 outputs the level switching signal LS at the H level.

Thereafter, when the elapsed time after the transition of the operation mode of the drive circuit 50 measured by the level switching control circuit 716 to the third mode MD3 reaches the time measurement time ta2, the level switching control circuit 716 sets the logic level of the level switching control signal SIG1 to the H level and sets the logic level of the level switching control signal SIG2 to the L level. Therefore, the output switching circuit 720 outputs, as the level switching signal LS, the pulse signal LSP output by the comparison circuit 714.

Then, when the elapsed time after the transition of the operation mode of the drive circuit 50 measured by the level switching control circuit 716 to the third mode MD3 reaches the time measurement time tb2, the level switching control circuit 716 detects the voltage value of the base drive signal aA. Here, the time measurement time tb2 is set to be longer than the time from a time point when the operation mode of the drive circuit 50 transitions to the third mode MD3 to a time point when the voltage value of the base drive signal aA is smaller than the threshold value dvth. Therefore, during the time measurement time tb2, the voltage value of the base drive signal aA detected by the level switching control circuit 716 is smaller than the threshold value dvth. The level switching control circuit 716 sets the logic level of the level switching control signal SIG1 as the L level and sets the logic level of the level switching control signal SIG2 as the L level because the voltage value of the base drive signal aA is smaller than the threshold value dvth. Therefore, the output switching circuit 720 outputs the level switching signal LS at the L level.

Thereafter, when the voltage value of the base drive signal aA reaches a predetermined voltage value, the voltage value of the base drive signal aA becomes constant. Accordingly, the operation mode of the drive circuit 50 transitions from the third mode MD3 to the first mode MD1.

As described above, a period in which the level switching signal LS constant at the L level is output, a period in which the pulse signal LSP is output as the level switching signal LS, and a period in which the level switching signal LS constant at the H level is output in the third mode MD3 when the operation mode of the drive circuit 50 transitions from the first mode MD1 to the second mode MD2 or from the second mode MD2 to the first mode MD1 are set for the level switching signal output circuit 710.

Specifically, in the case where the voltage value of the base drive signal aA changes across the threshold value dvth, that is, in the third mode MD3 in which the value of the base drive signal aA changes by switching the logic level of the level switching control signal SIG1 and the logic level of the level switching control signal SIG2 based on the timing information ST stored in the storage circuit 718, states of the level switching signal output circuit 710 include a state in which the level switching signal LS changing between the L level and the H level according to the feedback signal VFB1 is output, and a state in which the level switching signal LS constant at the L level or the H level is output. At a time point immediately after the transition from the first mode MD1 or the second mode MD2 in which the value of the base drive signal aA does not change to the third mode MD3 in which the value of the base drive signal aA changes and a time point immediately before the transition from the third mode MD3 in which the value of the base drive signal aA changes to the first mode MD1 or the second mode MD2 in which the value of the base drive signal aA does not change, the level switching signal output circuit 710 is in a state in which the level switching signal LS constant at the L level or the H level is output.

In the level switching signal output circuit 710 configured as described above, the pulse signal LSP is a signal obtained by comparing the voltage value of the feedback signal VFB1 with the voltage value of the reference signal REF, and is generated such that the voltage value of the feedback signal VFB1 follows the voltage value of the reference signal REF. When the level switching signal LS is generated using such a pulse signal LSP, the influence of the change in the load capacitance is reduced, and the waveform accuracy of the drive signal COM is improved even when the load capacitance of the piezoelectric element 60 or the like to which the drive signal COM to be output is supplied changes in the drive circuit 50.

On the other hand, when the level switching signal output circuit 710 outputs the level switching signal LS corresponding to the pulse signal LSP in the entire period of the third mode MD3 when the operation mode of the drive circuit 50 transitions from the first mode MD1 to the second mode MD2 or from the second mode MD2 to the first mode MD1, the period in which the switching operation in the amplifier circuit 550 and the switching operation in the level shift circuit 750 are executed in parallel increases, and thus the power consumption of the drive circuit 50 may increase.

In contrast, in the third mode MD3 when the operation mode of the drive circuit 50 transitions from the first mode MD1 to the second mode MD2 or from the second mode MD2 to the first mode MD1, the period in which the level switching signal LS constant at the L level is output, the period in which the pulse signal LSP is output as the level switching signal LS, and the period in which the level switching signal LS constant at the H level is output are set for the drive circuit 50 according to the embodiment, so that the waveform accuracy of the drive signal COM can be improved, and the possibility that the power consumption in the drive circuit 50 increases can be reduced.

Here, in the third mode MD3, the time measurement times ta1, ta2, tb1, and tb2 defining the period in which the level switching signal LS constant at the L level is output, the period in which the pulse signal LSP is output as the level switching signal LS, and the period in which the level switching signal LS constant at the H level is output may be appropriately adjusted according to the signal waveform of the drive signal COM output by the drive circuit 50 or the number of piezoelectric elements 60 driven by the drive signal COM. Here, the time measurement times ta1, ta2, tb1, and tb2 may be adjusted by storing the time measurement times ta1, ta2, tb1, and tb2 adjusted in advance in the storage circuit 718 and acquiring the optimal time measurement times ta1, ta2, tb1, and tb2 according to the operation status by the level switching control circuit 716, may be adjusted by adding a predetermined coefficient to the time measurement times ta1, ta2, tb1, and tb2 according to the drive status of the liquid ejection apparatus 1, or may be adjusted according to information input from the outside of the liquid ejection apparatus 1.

For example, when the period in which the voltage value of the base drive signal aA changes is long, the time measurement times ta1 and ta2 may be adjusted to be long. Accordingly, the period in which the switching operation in the amplifier circuit 550 and the switching operation in the level shift circuit 750 are executed in parallel is reduced, and the possibility that the power consumption in the drive circuit 50 increases is further reduced. For example, in the drive circuit 50, when the number of piezoelectric elements 60 to which the drive signal COM to be output is supplied is large, that is, when the load capacitance to which the drive signal COM to be output is supplied is large, the time measurement times ta1 and ta2 may be adjusted to be short. Accordingly, the period in which the pulse signal LSP is output as the level switching signal LS increases, and the waveform accuracy of the drive signal COM output by the drive circuit 50 is further improved. In the third mode MD3, when the slew rate is high, the time measurement times ta1 and ta2 may be adjusted to be short. Accordingly, the period in which the pulse signal LSP is output as the level switching signal LS increases, and the waveform accuracy of the drive signal COM output by the drive circuit 50 is further improved.

In addition, it is preferable that the time measurement times ta1 and ta2 are shorter than the time until the voltage value of the base drive signal aA crosses the threshold value dvth after the transition to the third mode MD3 as shown in FIG. 12, and the time measurement times tb1 and tb2 are longer than the time until the voltage value of the base drive signal aA crosses the threshold value dvth after the transition to the third mode MD3 as shown in FIG. 12. That is, it is preferable that the level switching signal output circuit 710 outputs the pulse signal LSP as the level switching signal LS at a timing when the voltage value of the base drive signal aA crosses the threshold value dvth.

As described above, the drive circuit 50 operates in the first mode MD1 during a period in which the voltage value of the base drive signal aA is smaller than the threshold value dvth, and operates in the second mode MD2 during a period in which the voltage value of the base drive signal aA is larger than the threshold value dvth. Therefore, at the timing when the voltage value of the base drive signal aA crosses the threshold value dvth, the reference potential of the first amplified modulation signal AMS1 output as the second amplified modulation signal AMS2 steeply changes. The level switching signal output circuit 710 outputs the level switching signal LS corresponding to the pulse signal LSP at the timing when the reference potential of the first amplified modulation signal AMS1 output as the second amplified modulation signal AMS2 steeply changes, which is an operation mode switching timing, so that the possibility that the signal waveform of the drive signal COM is distorted along with the switching of the operation mode of the drive circuit 50 is reduced.

As described above, in the drive circuit 50 according to the embodiment, the period in which the level switching signal LS constant at the L level is output, the period in which the pulse signal LSP is output as the level switching signal LS, and the period in which the level switching signal LS constant at the H level is output can be controlled to the optimum time in the third mode MD3 by adjusting the time measurement times ta1, ta2, tb1, and tb2. Accordingly, the waveform accuracy of the drive signal COM can be improved, and the possibility that the power consumption in the drive circuit 50 increases can be reduced.

Here, the piezoelectric element 60 is an example of a capacitive load, the drive signal COM is an example of the drive signal, and the drive circuit 50 corresponds to a capacitive load drive circuit. The base drive signal aA is an example of the base drive signal, and considering that the base drive signal aA is a signal obtained by converting the base drive signal dA into an analog signal, the base drive signal dA is also an example of the base drive signal. The differentiation circuit 712 is an example of a reference signal output circuit, the comparison circuit 714 is an example of a pulse signal output circuit, and the timing information ST stored in the storage circuit 718 is an example of information stored in the storage circuit. The period in which the operation mode of the drive circuit 50 is at least one of the first mode MD1 and the second mode MD2 is an example of a constant period, and the period in which the operation mode of the drive circuit 50 is the third mode MD3 is an example of a variable period. When the operation mode of the drive circuit 50 is the third mode MD3, a state of the level switching signal output circuit 710 when the level switching control signal SIG1 is at the H level and the level switching control signal SIG2 is at the L level is an example of a first state. When the operation mode of the drive circuit 50 is the third mode MD3, at least one of a state of the level switching signal output circuit 710 when the level switching control signal SIG1 is at the L level and the level switching control signal SIG2 is at the H level and a state of the level switching signal output circuit 710 when the level switching control signal SIG1 is at the L level and the level switching control signal SIG2 is at the L level is an example of a second state. The L level in the logic levels of the level switching signal LS is an example of a first potential, and the H level in the logic levels of the level switching signal LS is an example of a second potential. The feedback signal VFB1 is an example of a feedback signal, the level switching control signal SIG1 is an example of a first switching control signal, and the level switching control signal SIG2 is an example of a second switching control signal.

### 5. Functions and Effects

In the liquid ejection apparatus 1 according to the embodiment configured as described above, a plurality of kinds of signals having different voltage values, which include the voltage signal VD1 having a voltage value of the voltage vd1 obtained by boosting the voltage signal VDD, and the voltage signal VD2 having a voltage value of the voltage vd2 different from the voltage vd1 obtained by boosting the voltage signal VDD, are input to the drive circuit 50 provided in the head unit 20. The voltage conversion circuit 70 that outputs the voltage signal VD1 and the voltage signal VD2 includes the inductor Lsw having one end to which the voltage signal VDD is supplied, the transistor Msw having a drain terminal, which is one end, electrically coupled to the other end of the inductor Lsw, the diode Do1 having an anode terminal electrically coupled to the drain terminal that is one end of the transistor Msw, the capacitor Co1 having one end electrically coupled to the cathode terminal of the diode Do1, the capacitor Cb1 having one end electrically coupled to the drain terminal that is one end of the transistor Msw, the diode Db1 having an anode terminal electrically coupled to the cathode terminal of the diode Do1, the diode Do2 having an anode terminal electrically coupled to the cathode terminal of the diode Db1 and the other end of the capacitor Cb1, and the capacitor Co2 having one end electrically coupled to the cathode terminal of the diode Do2. The voltage value at one end of the capacitor Co1 is output as the voltage signal VD1, and the voltage value at one end of the capacitor Co2 is output as the voltage signal VD2.

Accordingly, the voltage conversion circuit 70 does not need to individually include an inductor element used in a booster circuit that generates the voltage signal VD1 from the voltage signal VDD and an inductor element used in a booster circuit that generates the voltage signal VD2 from the voltage signal VDD. In other words, in the liquid ejection apparatus 1 according to the embodiment, the voltage conversion circuit 70 provided in the head unit 20 can boost the voltage signal VDD only by the inductor Lsw which is one inductor element, and output voltage signals VD1 and VD2 having a plurality of different voltage values. Accordingly, the size of the voltage conversion circuit 70 can be reduced, and the possibility that the liquid ejection apparatus 1 and the head unit 20 will increase in size is reduced.

Further, in the liquid ejection apparatus according to the embodiment, the voltage conversion circuit 70 provided in the head unit 20 can boost the voltage signal VDD only by the inductor Lsw which is one inductor element, and can also output the voltage signals VD3 to VD5 in addition to voltage signals VD1 and VD2 having a plurality of different voltage values. Accordingly, the size of the voltage conversion circuit 70 can be reduced, and the possibility that the liquid ejection apparatus 1 and the head unit 20 will increase in size is further reduced.

In the liquid ejection apparatus 1 according to the embodiment configured as described above, when the voltage value of the base drive signal aA changes across the threshold value dvth, that is, when the drive circuit 50 is in the third mode MD3 in which the value of the base drive signal aA changes, states of the level switching signal output circuit 710 include a state in which the level switching signal LS changing between the L level and the H level according to the feedback signal VFB1 is output, and a state in which the level switching signal LS constant at the L level or the H level is output. Accordingly, in the drive circuit 50 according to the embodiment, the waveform accuracy of the drive signal COM output by the drive circuit 50 can be improved during the period in which the level switching signal output circuit 710 generates the level switching signal LS changing between the L level and the H level according to the feedback signal VFB1, and the possibility that the power consumption in the drive circuit 50 increases can be reduced during the period in which the level switching signal output circuit 710 outputs the level switching signal LS constant at the L level or the period in which the level switching signal output circuit 710 outputs the level switching signal LS constant at the H level.

That is, in the liquid ejection apparatus 1 according to the embodiment configured as described above, in the third mode MD3 when the operation mode of the drive circuit 50 transitions from the first mode MD1 to the second mode MD2 or from the second mode MD2 to the first mode MD1, the period in which the level switching signal LS constant at the L level is output, the period in which the pulse signal LSP is output as the level switching signal LS, and the period in which the level switching signal LS constant at the H level is output are set for the level switching signal output circuit 710, so that the waveform accuracy of the drive signal COM can be improved, and the possibility that the power consumption in the drive circuit 50 increases can be reduced.

### 6. Modification

### 6.1 Modification 1

In the liquid ejection apparatus 1 according to the embodiment described above, the voltage conversion circuit 70 outputs a signal of a voltage value at one end of the capacitor Co1 as the voltage signal VD1, outputs a signal of a voltage value at one end of the capacitor Co2 as the voltage signal VD2, outputs a signal of a voltage value at one end of the capacitor Co3 as the voltage signal VD3, outputs a signal of a voltage value at one end of the capacitor Co4 as the voltage signal VD4, and outputs a signal of a voltage value at one end of the capacitor Co5 as the voltage signal VD5. In the liquid ejection apparatus 1 according to Modification 1, as shown in FIG. 13, the voltage conversion circuit 70 further includes a diode Dk1 and a capacitor Ck1 provided in a propagation path through which the voltage signal VD1 propagates, and a diode Dk2 and a capacitor Ck2 provided in a propagation path through which the voltage signal VD2 propagates, a diode Dk3 and a capacitor Ck3 provided in a propagation path through which the voltage signal VD3 propagates, a diode Dk4 and a capacitor Ck4 provided in a propagation path through which the voltage signal VD4 propagates, and a diode Dk5 and a capacitor Ck5 provided in a propagation path through which the voltage signal VD5 propagates.

FIG. 13 is a diagram showing an example of a configuration of the voltage conversion circuit 70 according to Modification 1. As shown in FIG. 13, an anode terminal of the diode Dk1 is electrically coupled to the cathode terminal of the diode Do1 and one end of the capacitor Co1. A cathode terminal of the diode Dk1 is electrically coupled to one end of the capacitor Ck1. The ground potential is supplied to the other end of the capacitor Ck1. The voltage signal VD1, which is a signal of a voltage value at one end of the capacitor Co1, is output from the voltage conversion circuit 70 via the diode Dk1.

An anode terminal of the diode Dk2 is electrically coupled to the cathode terminal of the diode Do2 and one end of the capacitor Co2. A cathode terminal of the diode Dk2 is electrically coupled to one end of the capacitor Ck2. The ground potential is supplied to the other end of the capacitor Ck2. The voltage signal VD2, which is a signal of a voltage value at one end of the capacitor Co2, is output from the voltage conversion circuit 70 via the diode Dk2.

An anode terminal of the diode Dk3 is electrically coupled to the cathode terminal of the diode Do3 and one end of the capacitor Co3. A cathode terminal of the diode Dk3 is electrically coupled to one end of the capacitor Ck3. The ground potential is supplied to the other end of the capacitor Ck3. The voltage signal VD3, which is a signal of a voltage value at one end of the capacitor Co3, is output from the voltage conversion circuit 70 via the diode Dk3.

An anode terminal 41 the of diode Dk4 is electrically coupled to the cathode terminal of the diode Do4 and one end of the capacitor Co4. A cathode terminal of the diode Dk4 is electrically coupled to one end of the capacitor Ck4. The ground potential is supplied to the other end of the capacitor Ck4. The voltage signal VD4, which is a signal of a voltage value at one end of the capacitor Co4, is output from the voltage conversion circuit 70 via the diode Dk4.

An anode terminal of the diode Dk5 is electrically coupled to the cathode terminal of the diode Do5 and one end of the capacitor Co5. A cathode terminal of the diode Dk5 is electrically coupled to one end of the capacitor Ck5. The ground potential is supplied to the other end of the capacitor Ck5. The voltage signal VD5, which is a signal of a voltage value at one end of the capacitor Co5, is output from the voltage conversion circuit 70 via the diode Dk5.

That is, the voltage conversion circuit 70 according to Modification 1 includes the diode Dk1 having an anode terminal electrically coupled to one end of the capacitor Co1, the capacitor Ck1 having one end electrically coupled to the cathode terminal of the diode Dk1, the diode Dk2 having an anode terminal electrically coupled to one end of the capacitor Co2, the capacitor Ck2 having one end electrically coupled to the cathode terminal of the diode Dk2, the diode Dk3 having an anode terminal electrically coupled to one end of the capacitor Co3, the capacitor Ck3 having one end electrically coupled to the cathode terminal of the diode Dk3, the diode Dk4 having an anode terminal electrically coupled to one end of the capacitor Co4, the capacitor Ck4 having one end electrically coupled to the cathode terminal of the diode Dk4, the diode Dk5 having an anode terminal electrically coupled to one end of the capacitor Co5, and the capacitor Ck5 having one end electrically coupled to the cathode terminal of the diode Dk5.

In the voltage conversion circuit 70 according to Modification 1 configured as described above, even when the power consumption in the load to which the voltage signal VD1 is supplied fluctuates, the possibility that the voltage value at one end of the capacitor Co1 fluctuates is reduced by the diode Dk1. Similarly, even when the power consumption in the load to which the voltage signal VD2 is supplied fluctuates, the possibility that the voltage value at one end of the capacitor Co2 fluctuates is reduced by the diode Dk2. Even when the power consumption in the load to which the voltage signal VD3 is supplied fluctuates, the possibility that the voltage value at one end of the capacitor Co3 fluctuates is reduced by the diode Dk3. Even when the power consumption in the load to which the voltage signal VD4 is supplied fluctuates, the possibility that the voltage value at one end of the capacitor Co4 fluctuates is reduced by the diode Dk4. Even when the power consumption in the load to which the voltage signal VD5 is supplied fluctuates, the possibility that the voltage value at one end of the capacitor Co5 fluctuates is reduced by the diode Dk5.

As a result, in the voltage conversion circuit 70, the accuracy of the voltage values of the voltage signals VD2 to VD5 generated based on the voltage signal VD1 is also improved. That is, in the voltage conversion circuit 70 according to Modification 1, the voltage accuracy of each of the voltage signals VD1 to VD5 to be output can be improved.

At this time, the capacitance of the capacitor Ck1 is preferably larger than the capacitance of the capacitor Co1. The capacitance of the capacitor Ck2 is preferably larger than the capacitance of the capacitor Co2. The capacitance of the capacitor Ck3 is preferably larger than the capacitance of the capacitor Co3. The capacitance of the capacitor Ck4 is preferably larger than the capacitance of the capacitor Co4. The capacitance of the capacitor Ck5 is preferably larger than the capacitance of the capacitor Co5.

Accordingly, even when the power consumption in the load to which each of the voltage signals VD1 to VD5 is supplied greatly fluctuates, the fluctuation in the power consumption is more efficiently absorbed by the charges stored in the capacitors Ck1 to Ck5. Therefore, the possibility that the voltage value at one end of each of the capacitors Co1 to Co5 fluctuates is further reduced, and the voltage accuracy of each of the voltage signals VD1 to VD5 output by the voltage conversion circuit 70 is further improved.

The diodes Dk1 to Dk5 and the capacitors Ck1 to Ck5 may be used only when the fluctuation of the power consumption of the load to which the corresponding voltage signals VD1 to VD5 are supplied is large, and in this case, any one of the diodes Dk1 to Dk5 and the capacitors Ck1 to Ck5 may not be provided.

### 6.2 Modification 2

In the liquid ejection apparatus 1 according to the embodiment described above, the voltage conversion circuit 70 supplies the voltage signal VD3 to the drain terminal of the transistor M1 of the amplifier circuit 550 and supplies the voltage signal VD2 to the boost circuit BS of the level shift circuit 750. The signal supplied to the drain terminal of the transistor M1 of the amplifier circuit 550 may be selected from the voltage signals VD1 to VD5, and the signal supplied to the boost circuit BS of the level shift circuit 750 may be selected from the voltage signals VD1 to VD5. Here, in Modification 2 of the liquid ejection apparatus 1, a signal supplied to the drain terminal of the transistor M1 of the amplifier circuit 550 is referred to as a voltage signal VMS, and a signal supplied to the boost circuit BS of the level shift circuit 750 is referred to as a voltage signal VLS.

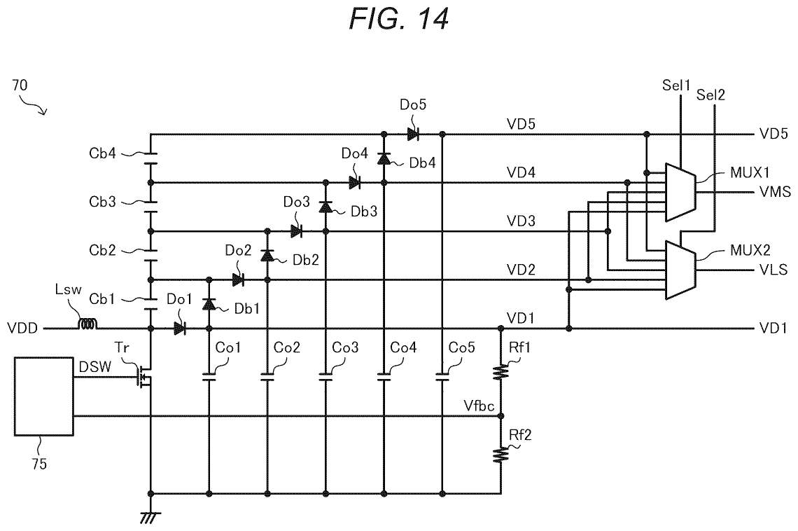

FIG. 14 is a diagram showing an example of a configuration of the voltage conversion circuit 70 according to Modification 2. As shown in FIG. 14, the voltage conversion circuit 70 provided in the liquid ejection apparatus 1 according to Modification 2 includes multiplexers MUX1 and MUX2.

The voltage signals VD1 to VD5 are input to an input terminal of the multiplexer MUX1. A selection control signal Sel1 is input to a control terminal of the multiplexer MUX1. The multiplexer MUX1 selects any one of the voltage signals VD1 to VD5 based on the selection control signal Sel1 input to the control terminal, and outputs the selected voltage signal as the voltage signal VMS. The voltage signal VMS is supplied to the drain terminal of the transistor M1 provided in the amplifier circuit 550 of the drive circuit 50.

The voltage signals VD1 to VD5 are input to an input terminal of the multiplexer MUX2. A selection control signal Sel2 is input to a control terminal of the multiplexer MUX2. The multiplexer MUX2 selects any one of the voltage signals VD1 to VD5 based on the selection control signal Sel2 input to the control terminal, and outputs the selected voltage signal as the voltage signal VLS. The voltage signal VLS is supplied to the boost circuit BS provided in the level shift circuit 750 of the drive circuit 50.

That is, the voltage conversion circuit 70 includes the multiplexer MUX1 that selects whether to supply the voltage signal VD1 to the transistor M1 provided in the amplifier circuit 550 of the drive circuit 50 and whether to supply the voltage signal VD2 to the transistor M1 provided in the amplifier circuit 550 of the drive circuit 50, and the multiplexer MUX2 that selects whether to supply the voltage signal VD1 to the boost circuit BS provided in the level shift circuit 750 of the drive circuit 50 and whether to supply the voltage signal VD2 to the boost circuit BS provided in the level shift circuit 750 of the drive circuit 50.

Here, the selection control signal Sel1 input to the control terminal of the multiplexer MUX1 and the selection control signal Sel2 input to the control terminal of the multiplexer MUX2 may be output by, for example, the control circuit 100. The control circuit 100 may output the selection control signals Sel1 and Sel2 according to the voltage amplitude of the drive signal COM. The control circuit 100 may acquire the ambient temperature of the liquid ejection head 21 and output the selection control signals Sel1 and Sel2 according to the acquired temperature. In addition, the control circuit 100 may output the selection control signals Sel1 and Sel2 according to the number of the piezoelectric elements 60 driven by the drive signal COM. Accordingly, the voltage value of the voltage signal VMS supplied to the transistor M1 provided in the amplifier circuit 550 and the voltage value of the voltage signal VLS supplied to the boost circuit BS provided in the level shift circuit 750 can be freely selected among the voltages vd1 to vd5 according to the operation status of the liquid ejection apparatus 1 such as the temperature of the liquid ejection head 21 and the number of piezoelectric elements 60 to be driven.

As a result, in the liquid ejection apparatus 1 according to Modification 2, the voltage value of the first amplified modulation signal AMS1 output by the amplifier circuit 550 and the shift amount of the reference potential of the first amplified modulation signal AMS1 having a level shifted by the level shift circuit 750 can be controlled according to the operation status of the liquid ejection apparatus 1, the drive signal COM having an optimal signal waveform corresponding to the operation status of the liquid ejection apparatus 1 can be output, and the signal can be amplified with an appropriate voltage value.

As described above, in the liquid ejection apparatus 1 according to Modification 2, the signal waveform of the drive signal COM output by the drive circuit 50 can be easily adjusted according to the operation status of the liquid ejection apparatus 1. Accordingly, the ejection accuracy of the ink ejected from the ejection unit 600 is improved. Further, in the liquid ejection apparatus 1 according to Modification 2, the voltage value of the voltage signal VMS supplied to the amplifier circuit 550 and the voltage value of the voltage signal VLS supplied to the level shift circuit 750 can be changed according to the operation status of the liquid ejection apparatus 1, and therefore, the switching loss in the amplifier circuit 550 and the switching loss in the level shift circuit 750 can be reduced by selecting the voltage vd which is a low voltage when the drive signal COM having a small voltage amplitude is output. Accordingly, the power consumption of the drive circuit 50 can be further reduced.

### 6.3 Modification 3

In the liquid ejection apparatus 1 according to the embodiment described above, the drive circuit 50 includes: the pulse modulation circuit 520 that modulates the base drive signal aA corresponding to the base drive signal dA serving as a base of the drive signal COM and outputs the modulation signal MS; the amplifier circuit 550 that includes the gate drive circuit 530 for outputting the gate signals HGD1 and LGD1 corresponding to the modulation signal MS and outputs the first amplified modulation signal AMS1 obtained by amplifying the modulation signal MS, the first amplified modulation signal AMS1 corresponding to the gate signals HGD1 and LGD1; the level switching signal output circuit 710 that outputs the level switching signal LS having a voltage value changing between the L level and the H level; the level shift circuit 750 that outputs the first amplified modulation signal AMS1 as the second amplified modulation signal AMS2 when the level switching signal LS is at the L level, and that outputs a signal obtained by shifting the level of the reference potential of the first amplified modulation signal AMS1 as the second amplified modulation signal AMS2 when the level switching signal LS is at the H level; the demodulation circuit 560 that demodulates the second amplified modulation signal AMS2 and outputs the drive signal COM; and the feedback circuit 570 that outputs the feedback signal VFB1 corresponding to the drive signal COM. The drive circuit 50 is not limited to the configuration described above, and a so-called class D amplifier circuit that modulates and then amplifies the base drive signal aA may be used.

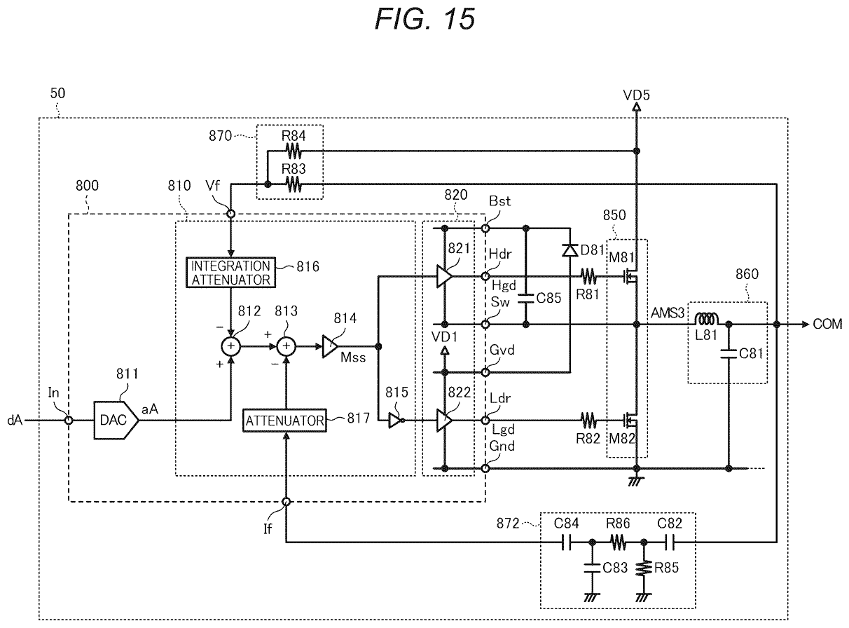

FIG. 15 is a diagram showing a configuration of the drive circuit 50 provided in the liquid ejection apparatus 1 according to Modification 3. As shown in FIG. 15, the drive circuit 50 according to Modification 3 includes an integrated circuit 800, an amplifier circuit 850, a demodulation circuit 860, feedback circuits 870 and 872, and other electronic components.

The integrated circuit 800 includes a plurality of terminals including a terminal In, a terminal Bst, a terminal Hdr, a terminal Sw, a terminal Gvd, a terminal Ldr, a terminal Gnd, a terminal Vf, and a terminal If. The integrated circuit 800 is electrically coupled to a substrate (not illustrated) provided on the outside via the plurality of terminals. The integrated circuit 800 includes a digital-to-analog converter (DAC) 811, a modulation circuit 810, and a gate drive circuit 820.

The digital base drive signal dA that defines a signal waveform of the drive signal COM is input to the DAC 811. The DAC 811 converts the input base drive signal dA into a base drive signal aA which is an analog signal, and outputs the base drive signal aA to the modulation circuit 810. A signal obtained by amplifying the base drive signal aA output by the DAC 811 corresponds to the drive signal COM.

The modulation circuit 810 generates a modulation signal Mss obtained by modulating the base drive signal aA and outputs the modulation signal Mss to the gate drive circuit 820. The modulation circuit 810 includes adders 812 and 813, a comparator 814, an inverter 815, an integration attenuator 816, and an attenuator 817.

The integration attenuator 816 attenuates and integrates the voltage value of the drive signal COM input via the terminal Vf, and outputs the drive signal COM after attenuation and integration to a negative input terminal of the adder 812. The base drive signal aA is input to a positive input terminal of the adder 812. The adder 812 outputs, to a positive input terminal of the adder 813, a signal obtained by subtracting the voltage value of the signal input to the negative input terminal from the voltage value of the signal input to the positive input terminal and integrating the result.

The attenuator 817 outputs, to a negative input terminal of the adder 813, a signal obtained by attenuating the high-frequency component of the drive signal COM input via the terminal If. The signal output from the adder 812 is input to the positive input terminal of the adder 813. The adder 813 generates a signal obtained by subtracting the voltage value of the signal input to the negative input terminal from the voltage value of the signal input to the positive input terminal, and outputs the signal to the comparator 814.

The comparator 814 outputs the modulation signal Mss obtained by pulse-modulating the signal input from the adder 813. Specifically, the comparator 814 generates and outputs the modulation signal Mss at the H level when the voltage value of the signal input from the adder 813 is equal to or higher than a predetermined threshold voltage in a case where the voltage value is increasing, and generates and outputs the modulation signal Mss at the L level when the voltage value of the signal input from the adder 813 is lower than the predetermined threshold voltage in a case where the voltage value is decreasing.

The modulation signal Mss output by the comparator 814 is input to a gate driver 821 provided in the gate drive circuit 820, and is also input to a gate driver 822 provided in the gate drive circuit 820 via the inverter 815. That is, signals having logic levels in an exclusive relation are input to the gate driver 821 and the gate driver 822. Here, the exclusive relation between the logic levels includes that the logic levels of the signals input to the gate driver 821 and the gate driver 822 are not simultaneously at the H level.

The gate drive circuit 820 includes the gate driver 821 and the gate driver 822. The gate driver 821 generates an amplification control signal Hgd by shifting the level of the modulation signal Mss input from the comparator 814, and outputs the amplification control signal Hgd from the terminal Hdr.

Specifically, among the power supply voltages of the gate driver 821, a high-side power supply voltage is supplied via the terminal Bst, and a low-side power supply voltage is supplied via the terminal Sw. The terminal Bst is coupled to one end of the capacitor C85 and a cathode of the diode D81 for preventing backflow. The terminal Sw is coupled to the other end of the capacitor C85. An anode of the diode D81 is coupled to the terminal Gvd. The voltage signal VD1 is supplied to the terminal Gvd. That is, the voltage signal VD1 is supplied to the anode of the diode D81. Therefore, a potential difference between the terminal Bst and the terminal Sw is approximately equal to the voltage vd1, which is the voltage value of the voltage signal VD1. As a result, the gate driver 821 generates the amplification control signal Hgd having a voltage value larger than that of the terminal Sw by the voltage vd1 according to the input modulation signal Mss, and outputs the amplification control signal Hgd from the terminal Hdr.

The gate driver 822 operates on the low potential side than the gate driver 821. The gate driver 822 generates an amplification control signal Lgd by shifting the level of the signal obtained by inverting, by the inverter 815, the logic level of the modulation signal Mss output from the comparator 814, and outputs the amplification control signal Lgd from the terminal Ldr.

Specifically, among the power supply voltages of the gate driver 822, the voltage signal VD1 is supplied as the high-side power supply voltage, and the ground potential is supplied as the low-side power supply voltage via the terminal Gnd. The gate driver 822 outputs the amplification control signal Lgd having a voltage value larger than that of the terminal Gnd by the voltage vd1 from the terminal Ldr according to the signal obtained by inverting the logic level of the input modulation signal Mss.

The amplifier circuit 850 includes a transistor M81 and a transistor M82.

The voltage signal VD5 is supplied to a drain terminal of the transistor M81 as an amplification power supply voltage of the amplifier circuit 850. A gate terminal of the transistor M81 is electrically coupled to one end of a resistor R81, and the other end of the resistor R81 is electrically coupled to the terminal Hdr of the integrated circuit 800. That is, the amplification control signal Hgd is input to the gate terminal of the transistor M81. A source terminal of the transistor M81 is electrically coupled to the terminal Sw of the integrated circuit 800.

A drain terminal of the transistor M82 is electrically coupled to the terminal Sw of the integrated circuit 800. That is, the drain terminal of the transistor M82 and the source terminal of the transistor M81 are electrically coupled to each other. A gate terminal of the transistor M82 is electrically coupled to one end of a resistor R82, and the other end of the resistor R82 is electrically coupled to the terminal Ldr of the integrated circuit 800. That is, the amplification control signal Lgd is input to the gate terminal of the transistor M82. The ground potential is supplied to a source terminal of the transistor M82.

When the drain terminal and the source terminal of the transistor M81 are controlled to be non-conductive and the drain terminal and the source terminal of the transistor M82 are controlled to be conductive, the potential of the terminal Sw is the ground potential. Therefore, the voltage vd1 is supplied to the terminal Bst. On the other hand, when the drain terminal and the source terminal of the transistor M81 are controlled to be conductive and the drain terminal and the source terminal of the transistor M82 are controlled to be non-conductive, the potential of the terminal Sw is the voltage vd5. Therefore, a signal having a voltage value equal to the sum of the voltage vd5 and the voltage vd1 is supplied to the terminal Bst. That is, the gate driver 821 that drives the transistor M81 generates the amplification control signal Hgd in which the L level is the voltage vd1 and the H level is the voltage value equal to the sum of the voltage vd5 and the voltage vd1 by changing the potential of the terminal Sw to the ground potential or the voltage vd5 according to the operation of the transistor M81 and the transistor M82 using the capacitor C85 as a floating power supply, and outputs the amplification control signal Hgd to the gate terminal of the transistor M81.

On the other hand, the gate driver 822 that drives the transistor M82 generates the amplification control signal Lgd in which the L level is the ground potential and the H level is the voltage vd1 regardless of the operations of the transistor M81 and the transistor M82, and outputs the amplification control signal Lgd to the gate terminal of the transistor M82.

The amplifier circuit 850 configured as described above generates the amplified modulation signal AMS3 obtained by amplifying the modulation signal Mss based on the voltage vd5 at a coupling point between the source terminal of the transistor M81 and the drain terminal of the transistor M82. The amplifier circuit 850 outputs the generated amplified modulation signal AMS3 to the demodulation circuit 860.

The demodulation circuit 860 generates the drive signal COM by demodulating the amplified modulation signal AMS3 output by the amplifier circuit 850, and outputs the drive signal COM from the drive circuit 50. The demodulation circuit 860 includes an inductor L81 and a capacitor C81. One end of the inductor L81 is coupled to one end of the capacitor C81. The amplified modulation signal AMS3 is input to the other end of the inductor L81. Further, the ground potential is supplied to the other end of the capacitor C81. That is, in the demodulation circuit 860, the inductor L81 and the capacitor C81 constitute a low pass filter. The demodulation circuit 860 demodulates the amplified modulation signal AMS3 by smoothing the amplified modulation signal AMS3 with the low pass filter, and outputs the demodulated signal as the drive signal COM.

The feedback circuit 870 includes a resistor R83 and a resistor R84. The drive signal COM is supplied to one end of the resistor R83, and the other end of the resistor R83 is coupled to the terminal Vf and one end of the resistor R84. The voltage signal VD5 is supplied to the other end of the resistor R84. Accordingly, the drive signal COM passing through the feedback circuit 870 is fed back to the terminal Vf while being pulled up by the voltage vd5.

The feedback circuit 872 includes capacitors C82, C83, and C84 and resistors R85 and R86. The drive signal COM is input to one end of the capacitor C82, and the other end of the capacitor C82 is coupled to one end of the resistor R85 and one end of the resistor R86. The ground potential is supplied to the other end of the resistor R85. Accordingly, the capacitor C82 and the resistor R85 function as a high pass filter. The other end of the resistor R86 is coupled to one end of the capacitor C84 and one end of the capacitor C83. The ground potential is supplied to the other end of the capacitor C83. Accordingly, the resistor R86 and the capacitor C83 function as a low pass filter. That is, the feedback circuit 872 includes a high pass filter and a low pass filter, and functions as a band pass filter that passes a signal in a predetermined frequency range included in the drive signal COM.

The other end of the capacitor C84 is coupled to the terminal If of the integrated circuit 800. Accordingly, a signal obtained by cutting a DC component among the high-frequency components of the drive signal COM passing through the feedback circuit 872 functioning as a band pass filter is fed back to the terminal If.

The drive signal COM is a signal obtained by smoothing the amplified modulation signal AMS3 based on the base drive signal dA by the demodulation circuit 860. The drive signal COM is integrated and subtracted via the terminal Vf, and then fed back to the adder 812. Accordingly, the drive circuit 50 self-oscillates at a frequency determined by the feedback delay and the feedback transfer function. However, since a delay amount of the feedback path via the terminal Vf is large, the frequency of the self-oscillation cannot be increased to such an extent that the accuracy of the drive signal COM can be sufficiently ensured only by the feedback via the terminal Vf. Therefore, the delay in the entire circuit is reduced by providing a path for feeding back the high-frequency component of the drive signal COM via the terminal If separately from the path via the terminal Vf. Accordingly, the frequency of the modulation signal Mss can be increased to such an extent that the accuracy of the drive signal COM can be sufficiently ensured as compared with a case where the path via the terminal If is not present.

As described above, in Modification 3 of the liquid ejection apparatus 1, the drive circuit 50 includes the amplifier circuit 850 including a transistor pair including the transistors M81 and M82, and the gate drive circuit 820 that drives the transistor pair including the transistors M81 and M82. The voltage signal VD1 is supplied to the gate drive circuit 820 that drives the transistor pair including the transistors M81 and M82 of the drive circuit 50, and the voltage signal VD5 is supplied to the amplifier circuit 850, which includes the transistor pair including the transistors M81 and M82, and the selection control circuit 200. That is, the voltage signal VD1 and the voltage signal VD5 among the voltage signals VD1 to VD5 output by the voltage conversion circuit 70 are supplied to the drive circuit 50 according to Modification 3 of the liquid ejection apparatus 1.

Even when the liquid ejection apparatus 1 includes the drive circuit 50 according to Modification 3 configured as described above, the voltage conversion circuit 70 can boost the voltage signal VDD only by the inductor Lsw which is one inductor element, and can output the voltage signals VD1 and VD5 having a plurality of different voltage values, so that the size of the voltage conversion circuit 70 can be reduced, and the concern that the liquid ejection apparatus 1 and the head unit 20 will increase in size can be reduced.

Although the embodiments have been described, the present disclosure is not limited to the embodiments and can be implemented in various aspects without departing from the gist thereof. For example, the above-described embodiments can be combined as appropriate.

The present disclosure includes substantially the same configuration as the configuration described in the embodiments, such as a configuration having the same function, the same method, and the same result, or a configuration having the same object and the same effect. The present disclosure has configurations obtained by replacing non-essential portions of the configurations described in the embodiments. The present disclosure includes configurations that can obtain the same functions and effects and configurations that can achieve the same object as the configurations described in the embodiments. The present disclosure has a configuration obtained by adding a known technique to the configuration described in the embodiments.

The following contents are derived from the above-described embodiment.

A capacitive load drive circuit according to an aspect is a capacitive load drive circuit for outputting a drive signal for driving a capacitive load, and the capacitive load drive circuit includes:
a modulation circuit configured to modulate a base drive signal serving as a basis of the drive signal and to output a modulation signal;
an amplifier circuit configured to output a first amplified modulation signal obtained by amplifying the modulation signal;
a level switching signal output circuit configured to output a level switching signal changing between a first potential and a second potential;
a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential;
a demodulation circuit configured to demodulate the second amplified modulation signal and to output the drive signal; and
a feedback circuit configured to output a feedback signal corresponding to the drive signal, in which
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

In the capacitive load drive circuit, when the state of the level switching signal output circuit, which outputs the level switching signal for switching whether the level shift circuit outputs the first amplified modulation signal as the second amplified modulation signal or outputs a signal obtained by shifting the level of the reference potential of the first amplified modulation signal as the second amplified modulation signal, includes the first state in which the level switching signal changing between the first potential and the second potential according to the feedback signal is output in the variable period in which the value of the base drive signal changes, the followability of the drive signal to the change in the value of the base drive signal can be improved, and the waveform accuracy of the drive signal can be improved. When the state of the level switching signal output circuit includes the second state in which the level switching signal constant at the first potential or the second potential is output, the switching loss in the level shift circuit can be reduced, and the power consumption in the drive circuit can be reduced. That is, in the capacitive load drive circuit, both the improvement in the waveform accuracy of the drive signal in the variable period in which the value of the base drive signal changes and the reduction in the power consumption can be achieved.

In the capacitive load drive circuit according to an aspect,
the state of the level switching signal output circuit may be the second state immediately after transition from a constant period in which the value of the base drive signal does not change to the variable period.

In the capacitive load drive circuit according to an aspect,
the state of the level switching signal output circuit may be the second state immediately before transition from the variable period to a constant period in which the value of the base drive signal does not change.

In the capacitive load drive circuit according to an aspect,
the level switching signal output circuit may include
   a level switching control circuit configured to output a first switching control signal and a second switching control signal for controlling switching of a potential of the level switching signal according to the base drive signal,
   a reference signal output circuit configured to output a reference signal corresponding to the base drive signal,
   a pulse signal output circuit configured to compare the reference signal with the feedback signal and to output a pulse signal corresponding to a comparison result, and
   an output switching circuit configured to switch, according to a logic level of the first switching control signal and a logic level of the second switching control signal, whether to output the level switching signal constant at the first potential, the level switching signal constant at the second potential, or the level switching signal changing between the first potential and the second potential according to the pulse signal.

The capacitive load drive circuit according to an aspect further includes:
a storage circuit, in which
the level switching signal output circuit may switch the logic level of the first switching control signal and the logic level of the second switching control signal based on information stored in the storage circuit.

In the capacitive load drive circuit, it is possible to easily set a period in which the first state is reached in which the level switching signal output circuit outputs the level switching signal changing between the first potential and the second potential according to the feedback signal in the variable period in which the value of the base drive signal changes, and a period in which the second state is reached in which the level switching signal constant at the first potential or the second potential is output. Accordingly, the state of the level switching signal output circuit can be optimally controlled according to the operation state of the capacitive load drive circuit and the signal waveform of the drive signal to be output, and both the improvement in the waveform accuracy of the drive signal in the variable period in which the value of the base drive signal changes and the reduction in the power consumption can be achieved in a more optimal state.

A liquid ejection apparatus according to an aspect includes:
a conveyance unit configured to convey a medium;
a liquid ejection head configured to eject a liquid onto the medium in response to driving of a capacitive load; and
a capacitive load drive circuit configured to output a drive signal for driving the capacitive load, in which
the capacitive load drive circuit includes
   a modulation circuit configured to modulate a base drive signal serving as a basis of the drive signal and to output a modulation signal,
   an amplifier circuit configured to output a first amplified modulation signal obtained by amplifying the modulation signal,
   a level switching signal output circuit configured to output a level switching signal changing between a first potential and a second potential,
   a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential,
   a demodulation circuit configured to demodulate the second amplified modulation signal and to output the drive signal, and
   a feedback circuit configured to output a feedback signal corresponding to the drive signal, and
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

In the liquid ejection apparatus, when the state of the level switching signal output circuit, which outputs the level switching signal for switching whether the level shift circuit outputs the first amplified modulation signal as the second amplified modulation signal or outputs a signal obtained by shifting the level of the reference potential of the first amplified modulation signal as the second amplified modulation signal, includes the first state in which the level switching signal changing between the first potential and the second potential according to the feedback signal is output in the variable period in which the value of the base drive signal changes, the followability of the drive signal to the change in the value of the base drive signal can be improved, and the waveform accuracy of the drive signal can be improved. When the state of the level switching signal output circuit includes the second state in which the level switching signal constant at the first potential or the second potential is output, the switching loss in the level shift circuit can be reduced, and the power consumption in the drive circuit can be reduced. That is, in the capacitive load drive circuit, both the improvement in the waveform accuracy of the drive signal in the variable period in which the value of the base drive signal changes and the reduction in the power consumption can be achieved.

In the liquid ejection apparatus according to an aspect,
the state of the level switching signal output circuit may be the second state immediately after transition from a constant period in which the value of the base drive signal does not change to the variable period.

In the liquid ejection apparatus according to an aspect,
the state of the level switching signal output circuit may be the second state immediately before transition from the variable period to a constant period in which the value of the base drive signal does not change.

In the liquid ejection apparatus according to an aspect,
the level switching signal output circuit may include
   a level switching control circuit configured to output a first switching control signal and a second switching control signal for controlling switching of a potential of the level switching signal according to the base drive signal,
   a reference signal output circuit configured to output a reference signal corresponding to the base drive signal,
   a pulse signal output circuit configured to compare the reference signal with the feedback signal and to output a pulse signal corresponding to a comparison result, and
   an output switching circuit configured to switch, according to a logic level of the first switching control signal and a logic level of the second switching control signal, whether to output the level switching signal constant at the first potential, the level switching signal constant at the second potential, or the level switching signal changing between the first potential and the second potential according to the pulse signal.

The liquid ejection apparatus according to an aspect further includes:
a storage circuit, in which
the level switching signal output circuit may switch the logic level of the first switching control signal and the logic level of the second switching control signal based on information stored in the storage circuit.

In the liquid ejection apparatus, it is possible to easily set a period in which the first state is reached in which the level switching signal output circuit outputs the level switching signal changing between the first potential and the second potential according to the feedback signal in the variable period in which the value of the base drive signal changes, and a period in which the second state is reached in which the level switching signal constant at the first potential or the second potential is output. Accordingly, the state of the level switching signal output circuit can be optimally controlled according to the operation state of the capacitive load drive circuit and the signal waveform of the drive signal to be output, and both the improvement in the waveform accuracy of the drive signal in the variable period in which the value of the base drive signal changes and the reduction in the power consumption can be achieved in a more optimal state.

A head unit according to an aspect includes:
a liquid ejection head configured to eject a liquid onto a medium in response to driving of a capacitive load; and
a capacitive load drive circuit configured to output a drive signal for driving the capacitive load, in which
the capacitive load drive circuit includes
   a modulation circuit configured to modulate a base drive signal serving as a basis of the drive signal and to output a modulation signal,
   an amplifier circuit configured to output a first amplified modulation signal obtained by amplifying the modulation signal,
   a level switching signal output circuit configured to output a level switching signal changing between a first potential and a second potential,
   a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential,
   a demodulation circuit configured to demodulate the second amplified modulation signal and to output the drive signal, and
   a feedback circuit configured to output a feedback signal corresponding to the drive signal, and
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

In the head unit, when the state of the level switching signal output circuit, which outputs the level switching signal for switching whether the level shift circuit outputs the first amplified modulation signal as the second amplified modulation signal or outputs a signal obtained by shifting the level of the reference potential of the first amplified modulation signal as the second amplified modulation signal, includes the first state in which the level switching signal changing between the first potential and the second potential according to the feedback signal is output in the variable period in which the value of the base drive signal changes, the followability of the drive signal to the change in the value of the base drive signal can be improved, and the waveform accuracy of the drive signal can be improved. When the state of the level switching signal output circuit includes the second state in which the level switching signal constant at the first potential or the second potential is output, the switching loss in the level shift circuit can be reduced, and the power consumption in the drive circuit can be reduced. That is, in the capacitive load drive circuit, both the improvement in the waveform accuracy of the drive signal in the variable period in which the value of the base drive signal changes and the reduction in the power consumption can be achieved.

In the head unit according to an aspect,
the state of the level switching signal output circuit may be the second state immediately after transition from a constant period in which the value of the base drive signal does not change to the variable period.

In the head unit according to an aspect,
the state of the level switching signal output circuit may be the second state immediately before transition from the variable period to a constant period in which the value of the base drive signal does not change.

In the head unit according to an aspect,
the level switching signal output circuit may include
   a level switching control circuit configured to output a first switching control signal and a second switching control signal for controlling switching of a potential of the level switching signal according to the base drive signal,
   a reference signal output circuit configured to output a reference signal corresponding to the base drive signal,
   a pulse signal output circuit configured to compare the reference signal with the feedback signal and to output a pulse signal corresponding to a comparison result, and
   an output switching circuit configured to switch, according to a logic level of the first switching control signal and a logic level of the second switching control signal, whether to output the level switching signal constant at the first potential, the level switching signal constant at the second potential, or the level switching signal changing between the first potential and the second potential according to the pulse signal.

The head unit according to an aspect further includes:
a storage circuit, in which
the level switching signal output circuit may switch the logic level of the first switching control signal and the logic level of the second switching control signal based on information stored in the storage circuit.

In the head unit, when the state of the level switching signal output circuit, which outputs the level switching signal for switching whether the level shift circuit outputs the first amplified modulation signal as the second amplified modulation signal or outputs a signal obtained by shifting the level of the reference potential of the first amplified modulation signal as the second amplified modulation signal, includes the first state in which the level switching signal changing between the first potential and the second potential according to the feedback signal is output in the variable period in which the value of the base drive signal changes, the followability of the drive signal to the change in the value of the base drive signal can be improved, and the waveform accuracy of the drive signal can be improved. When the state of the level switching signal output circuit includes the second state in which the level switching signal constant at the first potential or the second potential is output, the switching loss in the level shift circuit can be reduced, and the power consumption in the drive circuit can be reduced. That is, in the capacitive load drive circuit, both the improvement in the waveform accuracy of the drive signal in the variable period in which the value of the base drive signal changes and the reduction in the power consumption can be achieved.

What is claimed is:

1. A capacitive load drive circuit for outputting a drive signal for driving a capacitive load, the capacitive load drive circuit comprising:
a modulation circuit configured to modulate a base drive signal serving as a basis of the drive signal and to output a modulation signal;
an amplifier circuit configured to output a first amplified modulation signal obtained by amplifying the modulation signal;
a level switching signal output circuit configured to output a level switching signal changing between a first potential and a second potential;
a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential;
a demodulation circuit configured to demodulate the second amplified modulation signal and to output the drive signal; and
a feedback circuit configured to output a feedback signal corresponding to the drive signal, wherein
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

2. The capacitive load drive circuit according to claim 1, wherein
the state of the level switching signal output circuit is the second state immediately after transition from a constant period, in which the value of the base drive signal does not change, to the variable period.

3. The capacitive load drive circuit according to claim 1, wherein
the state of the level switching signal output circuit is the second state immediately before transition from the variable period to a constant period in which the value of the base drive signal does not change.

4. The capacitive load drive circuit according to claim 1, wherein
the level switching signal output circuit includes
a level switching control circuit configured to output a first switching control signal and a second switching control signal for controlling switching of a potential of the level switching signal according to the base drive signal,
a reference signal output circuit configured to output a reference signal corresponding to the base drive signal,
a pulse signal output circuit configured to compare the reference signal with the feedback signal and to output a pulse signal corresponding to a comparison result, and
an output switching circuit configured to switch, according to a logic level of the first switching control signal and a logic level of the second switching control signal, whether the level switching signal constant at the first potential or the level switching signal constant at the second potential, or the level switching signal changing between the first potential and the second potential according to the pulse signal.

5. The capacitive load drive circuit according to claim 4, further comprising:
a storage circuit, wherein
the level switching signal output circuit switches the logic level of the first switching control signal and the logic level of the second switching control signal based on information stored in the storage circuit.

6. A liquid ejection apparatus comprising:
a conveyance unit configured to convey a medium;
a liquid ejection head configured to eject a liquid onto the medium in response to driving of a capacitive load; and
a capacitive load drive circuit configured to output a drive signal for driving the capacitive load, wherein
the capacitive load drive circuit includes
a modulation circuit configured to modulate a base drive signal serving as a basis of the drive signal and to output a modulation signal,
an amplifier circuit configured to output a first amplified modulation signal obtained by amplifying the modulation signal,
a level switching signal output circuit configured to output switching signal changing between a first potential and a second potential,
a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential,
a demodulation circuit configured to demodulate the second amplified modulation signal and to output the drive signal, and
a feedback circuit configured to output a feedback signal corresponding to the drive signal, and
a state of the level switching signal output circuit includes a first state in which the level switching signal changing between the first potential the second potential according to the feedback signal is output in a variable period in which a value of the base drive signal changes, and a second state in which the level switching signal constant at the first potential or the second potential is output.

7. The liquid ejection apparatus according to claim 6, wherein
the state of the level switching signal output circuit is the second state immediately after transition from a constant period, in which the value of the base drive signal does not change, to the variable period.

8. The liquid ejection apparatus according to claim 6, wherein
the state of the level switching signal output circuit is the second state immediately before transition from the variable period to a constant period in which the value of the base drive signal does not change.

9. The liquid ejection apparatus according to claim 6, wherein
the level switching signal output circuit includes
a level switching control circuit configured to output a first switching control signal and a second switching control signal for controlling switching of a potential of the level switching signal according to the base drive signal,
a reference signal output circuit configured to output a reference signal corresponding to the base drive signal,
a pulse signal output circuit configured to compare the reference signal with the feedback signal and to output a pulse signal corresponding to a comparison result, and
an output switching circuit configured to switch, according to a logic level of the first switching control signal and a logic level of the second switching control signal, whether to output the level switching signal constant at the first potential or the level switching signal constant at the second potential, or the level switching signal changing between the first potential and the second potential according to the pulse signal.

10. The liquid ejection apparatus according to claim 9, further comprising:
a storage circuit, wherein
the level switching signal output circuit switches the logic level of the first switching control signal and the logic level of the second switching control signal based on information stored in the storage circuit.

11. A head unit comprising:
a liquid ejection head configured to eject a liquid onto a medium in response to driving of a capacitive load; and
a capacitive load drive circuit configured to output a drive signal for driving the capacitive load, wherein
the capacitive load drive circuit includes
a modulation circuit configured to modulate a base drive signal serving as a basis of the drive signal and to output a modulation signal,
an amplifier circuit configured to output a first amplified modulation signal obtained by amplifying the modulation signal,
a level switching signal output circuit configured to output a level switching signal changing between a first potential and a second potential,
a level shift circuit configured to output the first amplified modulation signal as a second amplified modulation signal when the level switching signal is at the first potential, and to output, as the second amplified modulation signal, a signal obtained by shifting a level of a reference potential of the first amplified modulation signal when the level switching signal is at the second potential,
a demodulation circuit configured to demodulate the second amplified modulation signal and to output the drive signal, and
a feedback circuit configured to output a feedback signal corresponding to the drive signal, and
a state of the level switching signal output circuit includes a first state in which the level switching signal changing between the first potential and the second potential according to the feedback signal is output in a variable period in which a value of the base drive signal changes, and a second state in which the level switching signal constant at the first potential or the second potential is output.

12. The head unit according to claim 11, wherein
the state of the level switching signal output circuit is the second state immediately after transition from a constant period, in which the value of the base drive signal does not change, to the variable period.

13. The head unit according to claim 11, wherein
the state of the level switching signal output circuit is the second state immediately before transition from the variable period to a constant period in which the value of the base drive signal does not change.

14. The head unit according to claim 11, wherein
the level switching signal output circuit includes
a level switching control circuit configured to output a first switching control signal and a second switching signal for controlling switching of a potential of the level switching signal according to the base drive signal,
a reference signal output circuit configured to output a reference signal corresponding to the base drive signal,
a pulse signal output circuit configured to compare the reference signal with the feedback signal and to output a pulse signal corresponding to a comparison result, and
an output switching circuit configured to switch, according to a logic level of the first switching control signal and a logic level of the second switching control signal, whether to output the level switching signal constant at the first potential or the level switching signal constant at the second potential, or the level switching signal changing between the first potential and the second potential according to the pulse signal.

15. The head unit according to claim 14, further comprising:
a storage circuit, wherein
the level switching signal output circuit switches the logic level of the first switching control signal and the logic level of the second switching control signal based on information stored in the storage circuit.
